(19) United States
(12) Patent Application Publication
(10) Pub. No.: US 2026/0267631 A1
(43) Pub. Date: Sep. 10, 2026

(54) NEURAL NETWORK UPDATE TO IMPROVE RUNTIME OPERATION

(71) Applicant: Synaptics Incorporated, San Jose, CA (US)

(72) Inventor: Able Eldhose, Ernakulam (IN)

(73) Assignee: Synaptics Incorporated, San Jose, CA (US)

(21) Appl. No.: 19/070,260

(22) Filed: Mar. 4, 2025

(51) Int. Cl. G06F 8/65

(52) U.S. Cl. CPC G06F 8/65

(57) ABSTRACT

This disclosure provides implementations for updating a neural network to improve execution of the neural network, including reducing the number of operations to be executed and processing resources and time required to execute the neural network. The implementations also relate to updating the neural network without requiring changes to a neural network framework or firmware. In some aspects, updating the neural network includes replacing a defined object in the neural network (such as an operator or group of operators in a layer all the way up to the layer itself of the neural network) with a specialized operator that is to call a specialized kernel that optimizes the replaced object. The specialized kernel requires fewer computing resources (such as fewer operations) to be executed than the replaced object. The specialized kernel may replace a layer of the neural network or be inserted between layers of the neural network.

### TECHNICAL FIELD

The present implementations relate generally to neural networks, and specifically to framework independent updates to a neural network.

### BACKGROUND OF RELATED ART

Neural networks (NNs) are a class of machine learning (ML) models for various applications, such as classification problems (such as image classification), recognition problems (such as handwriting recognition or facial recognition), and routing and control problems (such as network routing). An NN is coded in a programming language, such as Python, C, C++, Java, etc., and compiled to generate a general (untrained) model with hyperparameters to be set to configure the NN. The NN is then trained to determine and set the hyperparameters to configure the NN for use. If the NN is to be included in a plurality of devices, the trained NN is then deployed to those devices for execution at the device.

Various operating environments (also referred to as platforms) may be used to configure a NN before deployment. One example platform is TensorFlow, which is an end-to-end open source machine learning platform. A developer may use TensorFlow to visualize an NN (or other ML models) that is programmed in a programming language (such as C), with TensorFlow being used to train the NN so that the NN is ready for deployment. Changes to an NN after deployment typically require the entirety of an old NN to be replaced by a new NN including the changes (such as via an over the air (OTA) update). A problem with replacing the entirety of the NN is that low memory devices may have insufficient available memory for such an update. In addition, a typical NN may cause wasted operations to be performed by the device for some use cases and datasets, which may be especially detrimental for low power devices. As such, there is a need to improve operations and updates of an NN, particularly for low power or low memory devices.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method for updating a neural network. The method includes scanning, by a software module, a neural network for one or more defined objects. The software module is included in an operating environment for the neural network. The method also includes identifying an object from the one or more defined objects in the neural network, generating a specialized operator based on an object type of the object in response to identifying the object, and inserting the specialized operator into the neural network.

Another innovative aspect of the subject matter of this disclosure can be implemented in a system for updating a neural network, including a processing system and a memory. The memory stores computer readable code implementing a neural network and computer readable code implementing an operating environment for the neural network, with the operating environment including a software module. The memory also stores instructions that, when executed by the processing system, cause the system to perform operations including scanning, by the software module, the neural network for one or more defined objects. The operations also include identifying an object from the one or more defined objects in the neural network, generating a specialized operator based on an object type of the object in response to identifying the object, and inserting the specialized operator into the neural network.

### BRIEF DESCRIPTION OF THE DRAWINGS

The present implementations are illustrated by way of example and are not intended to be limited by the Figures of the accompanying drawings.

FIG. 1 shows an example convolutional neural network as visualized in TensorFlow.

FIG. 2 shows an example neural network with one or more specialized kernels inserted into the neural network, according to some implementations.

FIG. 3 shows a block diagram of an example system for implementing and updating a neural network, according to some implementations.

FIG. 4 shows a portion of an example kernel in which at least a portion of the parameters are to be replaced with constants, according to some implementations.

FIG. 5 shows a portion of an example specialized kernel generated from the example kernel depicted in FIG. 4 in which at least a portion of the parameters are replaced with constants, according to some implementations.

FIG. 6 shows an example defined object in which at least a portion of the parameters are to be replaced with constants, according to some implementations.

FIG. 7 shows an example specialized kernel generated from the defined object depicted in FIG. 6 in which at least a portion of the parameters are replaced with constants, according to some implementations.

FIG. 8 shows a visual conceptualization of simplifying the specialized kernel depicted in FIG. 7 by a compiler at compilation, according to some implementations.

FIG. 9 shows an illustrative flowchart depicting an example operation for typically performing an image data capture function.

FIG. 10 shows an illustrative flowchart depicting an example operation for typically performing an image data capture function to improve the frame per second of the image data capture as depicted in FIG. 9.

FIG. 11 shows example memory allocations for a system performing the operation depicted in FIG. 9 and the operation depicted in FIG. 10.

FIG. 12 shows example memory allocations for a system performing an inference (e.g., an iteration of operation 900) based on an offline memory allocation.

FIG. 13 shows example memory allocations for a system performing an inference operation based on an offline memory allocation that includes an input capture trigger.

FIG. 14 shows an example neural network for which a specialized kernel is to be added for a memory allocation function, according to some implementations.

FIG. 15 shows an illustrative flowchart depicting an example operation for updating a neural network, according to some implementations.

FIG. 16 shows an illustrative flowchart depicting an example operation for generating and storing a specialized kernel to update a neural network, according to some implementations.

FIG. 17 shows an illustrative flowchart depicting an example operation for generating and storing a specialized kernel as machine code to be executed for a specialized operator, according to some implementations.

FIG. 18 shows an illustrative flowchart depicting an example operation for replacing one or more broadcast operators with a specialized operator to use a lookup table, according to some implementations.

FIG. 19 shows an illustrative flowchart depicting an example operation for generating a lookup table to be used in replacing a broadcast operator, according to some implementations.

FIG. 20 shows an illustrative flowchart depicting an example operation for determining whether a broadcast operator is to be replaced, according to some implementations.

FIG. 21 shows an illustrative flowchart depicting an example operation for replacing a broadcast operator prevented from being replaced with the use of a lookup table with a specialized kernel, according to some implementations.

FIG. 22 shows an illustrative flowchart depicting an example operation for inserting an input capture trigger, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the Figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, updating a neural network (NN), especially at a deployed device, may be difficult. For example, if an NN is originally prepared in TensorFlow, the list of operators to be executed for the NN is collected using OpResolver at compilation (which converts the operator codes and names into machine code, such as binary or hexadecimal), and that list of operators in machine code is stored in a device memory that executes the NN. If the NN would be updated such that some operators may change, the device is unable to execute the new operators if not stored in memory. As such, the entire updated NN would need to be provided in an update to the device (which includes machine code of the new operators). Otherwise, in order for all of the updated NN to not be provided to the device, the device would be required to store the machine code of all possible operators that could potentially be used in the future for the NN. Storing all possible operators may be impossible for low memory devices, as the number of operators may be so large that the device has insufficient memory to store all of the operators. As such, the entirety of an updated NN with the machine code of the new operators would be required to be provided in a firmware (FW) update for an operating environment to the device (such as via an OTA update). However, a low memory device may also not have sufficient memory to store the FW update file large enough to include the entirety of the updated NN, as the device would be required to have sufficient memory to store both the current FW and the new FW file at the same time.

In addition, a general NN may be trained for a variety of different applications. However, some applications may cause a trained NN to be inefficiently implemented such that a device executing the NN wastes time and processing resources executing operations associated with the inefficient implementation. For example, a layer of the NN trained for a particular application may output the same results or receive the same inputs every time the NN is executed. A general kernel of the layer configured to receive a set of inputs of a known size and to provide an output of a known size requires a specific number of operations to be performed by the device to execute the kernel for the layer. Even if at least some of the inputs are always the same for the layer, those inputs are treated as general inputs to the kernel, and the device performs the specific number of operations required for the layer. For an application in which at least some inputs to a layer are static, the layer could be optimized in the programming code to reduce the number of operations required for the layer. However, since an NN may be deployed to a plurality of devices for different applications or use cases, each specific application would require the NN to be optimized especially for that application, which increases development time and resources to implement the NN for the various different applications, as well as unique OTA updates to each device to include a unique version of the NN.

Further, an NN may include one or more functions requiring the allocation of memory (referred to herein as a memory allocation function) during execution of the NN. For example, a camera or image data capture function to be executed in the NN to obtain data from an image sensor may include a first memory allocation command to allocate a first portion of memory to receive the data from the image sensor and a second memory allocation command to allocate a second portion of memory used in performing inference on the received data from the first portion of memory. The gathering of data requires a first amount of time, and the inference of the gathered data requires a second amount of time. If a plurality of layers of the NN include a memory allocation function, the amount of time to perform the memory allocation functions may delay execution of the NN. Typical means of optimizing memory allocation functions to reduce the amount of time needed to process the functions requires additional memory allocation, which may be sparse for limited memory devices.

As such, there is a need to improve optimization of an NN, especially for low memory devices. For example, there is a need to update an NN on an as needed basis to improve the performance of the NN that does not require manual changes to the NN itself. To note, improving the NN can include the replacement of a layer with a specialized kernel, the insertion of a specialized kernel to improve execution and memory utilization for one or more layers of the NN, and the insertion of one or more kernels to perform dynamic pre-processing of the input data or post-processing of the output data without requiring changes to the NN framework itself.

Various aspects relate generally to neural networks, and more particularly, to the process of updating neural networks to improve execution and updates to the neural networks. In some implementations, a software module of an operating environment for an NN scans the neural network for one or more defined objects, identifies an object from the one or more defined objects in the neural network, generates a specialized operator based on an object type of the object in response to identifying the object, and inserts the specialized operator into the NN. The specialized operator is to call a specialized kernel that is generated and stored separate from the NN in memory, with the specialized kernel corresponding to a parameter of the NN.

As used herein, a defined object may refer to one or more operators in a programming language to be compiled for the NN (or machine code corresponding to the operators after compilation), one or more conditions or statements defined in the programming language to be compiled for the NN (or machine code corresponding to the conditions or statements after compilation), one or more functions, and so on up to a layer of the NN in the programming language to be compiled or in the machine code after compilation. Also as used herein, a specialized operator may refer to a programming language script or machine code to reference or call the specialized kernel. Further as used herein, a parameter may refer to an input to a layer of the NN, a constraint or hyperparameter of the layer of the NN, or a result generated by one or more operations of the layer of the NN (which may be output by the NN or used by the NN to generate an output). A specialized kernel may refer to machine code to perform at least a portion of the operations of the layer or operations to occur before or after a layer (such as pre-processing input data or post-processing output data). For example, for a convolutional NN (CNN), a specialized kernel for a CNN layer may include fixed values for one or more inputs to the layer as well as specific weights used to perform the convolution operation at the layer.

Particular implementations of the subject matter described in this disclosure can be implemented to realize one or more of the following potential advantages. Through the introduction of specialized operators to call specialized kernels, aspects of the present disclosure allow for updating a NN (especially while deployed) without requiring a complete firmware update to replace the entire NN. In addition, a NN may be optimized using specialized operators and specialized kernels stored separate from the NN on a case-by-case basis without manually revising and updating the NN itself across all devices. As such, aspects of the present disclosure provide a flexible framework to update and improve NNs that does not require significant manual intervention on a case-by-case basis, especially for mass deployed NNs or for low memory and/or low power devices executing the NN.

The examples described below are for clarity in describing aspects of the present disclosure. In the examples, an NN is depicted as being programmed in the C or C++ programming language, but another suitable programming language may be used (such as Python or Java). In addition, the NN is depicted as being prepared and implemented in TensorFlow, but another suitable operating environment/platform may be used. To note, TensorFlow may be used herein to refer to TensorFlow itself as well as other software packages (also referred to as software modules) that may be installed on a computing system and integrated into TensorFlow (such as VisualBlocks, Keras, etc.). TensorFlow (TF) may also be used herein to refer to the TensorFlow family of environments, which includes TensorFlow Lite (TFLite), an operating environment for low power or low memory devices to execute ML models (such as an NN).

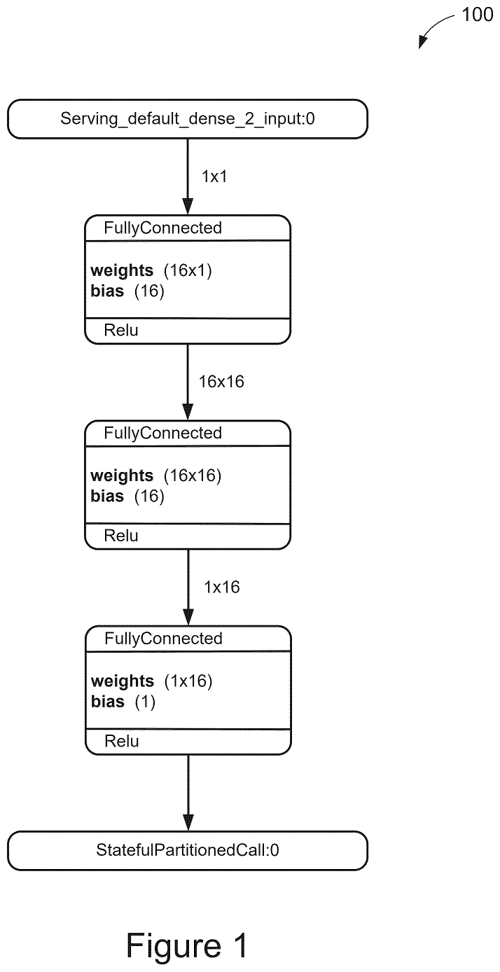

FIG. 1 shows an example convolutional neural network (CNN) 100 as visualized in TensorFlow. As depicted, the CNN 100 is a general NN that includes three fully connected middle layers for performing the convolution of the input data received at the input layer defined by the statement “Serving_default_dense_2_input:0” to generate the output data at the output layer defined by the statement “StatefulPartitionedCall:0”. Typically when the CNN 100 is implemented for execution (such as being encoded into a TF file or TFLite file and compiled into machine code), each middle layer includes a general kernel to include the weights and the biases used to perform the convolution at the layer. As such, the input to the middle layer is based on the output of a previous layer. For example, for the second middle layer that stores 256 weights (16×16) and 16 biases to generate a 1×16 output, the 16×16 input is based on the output of the first middle layer.

However, for some use cases of the NN, some of the 256 inputs to the second middle layer may be the same each time the NN is executed. For example, one or more inputs may be generated to always be a 0 by the weights in the previous layer causing values to converge to 0 for the corresponding one or more outputs from the previous layer. As such, a specialized kernel for the second middle layer may be generated to include the static values. The specialized kernel with the known inputs may be used in TensorFlow (such as by the compiler) to condense the second middle layer and reduce the number of operations required to perform the second middle layer.

To note, while one trained version of the NN may converge some inputs for a successive layer to a specific value, another trained version of the NN may have those inputs variable. Alternatively, different inputs may be static for a different trained version of the NN. In addition, pre-processing or post-processing of data may be desired for one version of the NN, while different or no pre-processing or post-processing of the data may be desired for a different version of the NN. Further, for other types of NNs, operations to be performed within a layer may include operations that could alternatively be performed before the layer (such as concurrently with a previous layer) so that data generated by those operations are ready for the layer. As such, one or more specialized kernels would need to be generated for each NN. A unique software module described herein automatically generates specialized kernels as desired, which may be during the initial implementation of the NN or may be to update the NN after deployment.

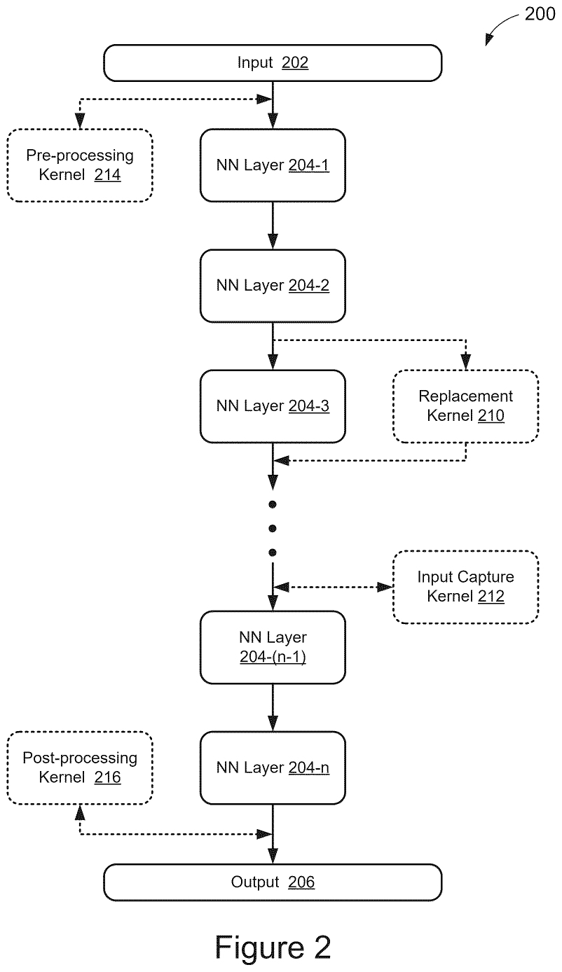

FIG. 2 shows an example NN 200 with one or more specialized kernels inserted into the NN 200, according to some implementations. The insertion of a specialized kernel herein refers to the insertion of a specialized operator to call the specialized kernel for execution. As depicted, the NN 200 includes an input layer 202, n middle NN layers 204-1 through 204-n (with n being an integer greater than 0), and an output layer 206. The NN 200 is a general NN that may be trained as desired for different use cases.

For a specific NN, the NN layer 204-3 may be configured to receive at least some static inputs or have other static parameters that would have allowed the NN layer 204-3 to be optimized by the compiler if known at compilation. In some implementations, a software module of the operating environment (such as TensorFlow) generates a specialized kernel to replace NN layer 204-3 (depicted as replacement kernel 210). For example, if the NN layer 204-3 is a convolution layer such as depicted in the CNN 100, the replacement kernel 210 may include the static inputs and parameters as well as the determined weights and biases to perform the convolution. The specialized kernel may also include the code to perform the operations of the NN layer 204-3, but optimized by a compiler based on the static inputs and parameters. The software module generates a specialized operator and inserts the specialized operator into a location in the code of the NN indicating where the NN layer 204-3 is to begin so that the replacement kernel 210 is called to perform the operations of the NN layer 204-3. In inserting the specialized operator, the software module prevents the code of the NN layer 204-3 from being executed (such as by commenting out or otherwise causing to skip a general operator in the NN to call the general kernel for the NN layer 204-3).

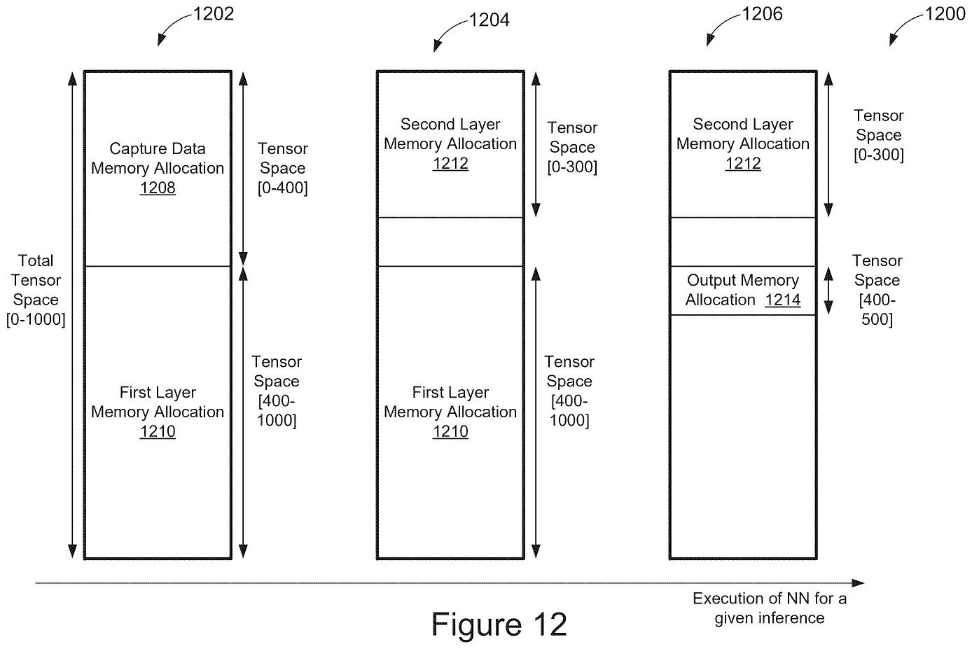

For a specific NN, the NN layer 204-2 or a subsequent layer may include a memory allocation function. For example, for a memory allocation function that requires pulling and processing image data from an image sensor, the function in the NN 200 may include commands to allocate memory (e.g., a portion of a tensor space for the NN) for receiving the image data and to allocate memory (e.g., a separate portion of the tensor space for the NN) for performing inference on the image data for use. The function also includes the commands to perform the operations of obtaining the data and performing inference on the data using the allocated memory. Various instances of the memory allocation function may also be included in one or more subsequent layers of the NN 200. Without optimization, the memory allocation functions are executed in a sequential manner without overlap, which may extend the amount of time needed to execute the NN 200. A typical means of expediting execution and/or reducing memory usage by the NN is through the use of offline memory allocation, in which memory allocation for the NN is pre-determined before execution (e.g., before compilation of the NN into machine code), such that, for example, certain portions of the memory used for an inference operation may be re-allocated within the same inference operation. However, allocation of memory for capturing image data for a subsequent inference operation, and consequently capturing that image data, may be delayed if the memory to be allocated for receiving the image data is to be utilized by the NN for the current inference operation (such as described below with reference to FIG. 12).

However, an input data capture function, including a corresponding memory allocation function, may be performed during execution of the NN for a first inference operation so that the input data (e.g., image data) for a second, subsequent inference operation may be ready prior to completion of the first inference operation. In particular, an input data capture function for capturing input data, and the corresponding memory allocation function, may be executed once sufficient memory (such as an adequate tensor space) is free and not to be used further for the first inference operation during execution of the NN. As such, the software module generates a specialized kernel (such as input capture kernel 212) to allocate memory (such as a tensor space), perform the memory allocation function, and to capture the input data into the allocated memory. The software module may add the kernel to the NN at a point in which memory usage by the NN for a given inference has passed a peak and the memory to be allocated for capturing input data is available for the memory allocation function. The software module may analyze the NN to identify a point at which to insert the input capture kernel and to determine an offline memory allocation for the NN in view of the input capture kernel. The input capture kernel does not require additional commands, such as a copy command, or memory to optimize execution of the input data capture function. With the input capture kernel 212 inserted into to the NN at a point prior to output 206, the input capture kernel 212 may be executed before a current inference operation is completed during execution of the NN. The software module generates and inserts a specialized operator to call the input capture kernel 212 at a location in the code of the NN 200 (such as before the NN layer 204-(n-1) begins), with the input capture kernel 212 including the memory allocation commands as well as the other commands of the memory allocation function and the input data capture function. While the input capture kernel 212 is depicted as being added immediately before the NN layer 204-(n-1) (such as inserting the specialized operator in the NN code immediately before the location corresponding to the beginning of the NN layer 204-(n-1)), the input capture kernel 212 may be inserted at any other suitable location between layers, or even within a layer, based on an analysis of the NN by the software module. As such, the input capture kernel 212 serves as a trigger for memory allocation and input data capture (“input capture trigger”) within the NN and the offline memory allocation. The input capture kernel 212 triggers input data capture in an asynchronous way relative to the current inference operation; the input data for the subsequent inference is captured parallel with the current inference operation.

In some implementations, the input capture kernel 212 does not include an input data capture function or even a memory allocation function. Instead, the input capture kernel 212 signals to the operating environment that memory for capturing input data is available and ready based on an offline memory allocation that pre-allocates memory for the NN 200 in view of the input capture kernel 212. Based on the signal that memory for capturing input data is available, the operating environment may capture input data into the memory parallel with continuing execution of the NN 200.

For a specific NN, it may be desired to include pre-processing of the data from the input layer 202 or post-processing of the output data to the output layer 206. Instead of inserting a general layer for pre-processing or a general layer for post-processing into the NN itself, the software module generates a specialized kernel for pre-processing (pre-processing kernel 214) of a specialized kernel for post-processing (post-processing kernel 216). For pre-processing, the software module generates a specialized operator to call the pre-processing kernel 214 and inserts the specialized operator in the NN code at a location between the input layer 202 and the NN layer 204-1. For post-processing, the software module generates a specialized operator to call the post-processing kernel 216 and inserts the specialized operator in the NN code at a location between the NN layer 204-n and the output layer 206. The pre-processing kernel 214 defines the outputs of the input layer 202 as the inputs to the kernel 214, defines the inputs to the NN layer 204-1 as the outputs of the kernel 214, and includes the operations to be performed on the inputs to the kernel 214 to generate the outputs of the kernel 214. The post-processing kernel 216 defines the outputs of the NN layer 204-n as the inputs to the kernel 216, defines the inputs to the output layer 206 as the outputs of the kernel 216, and includes the operations to be performed on the inputs to the kernel 216 to generate the outputs of the kernel 216.

Through the above described use of specialized kernels, a software module may completely update an NN without changing the framework of the NN. As noted above, the specialized kernels may be stored in memory separate from the NN, with only the specialized operators inserted (to add or replace a portion of the machine code). For example, for a TF file or a TFLite file, one or more specialized kernels may be compiled and stored as machine code in one or more tensors included in the file. A specialized operator may thus call the corresponding tensor(s) to be executed. As such, an NN may be updated or optimized using the calls to separately stored machine code without requiring a change to the general NN model itself that would require a firmware update at the device.

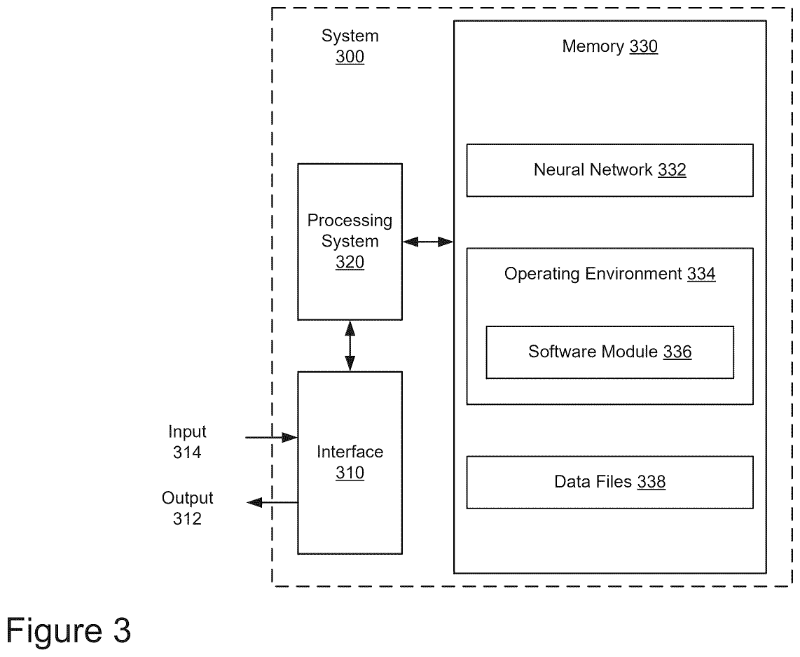

FIG. 3 shows a block diagram of an example system 300 for implementing and updating an NN 332, according to some implementations. The system 300 may be included in a device to implement the NN 332 before deployment or may be included in a device storing a deployed NN 332 for use. The system 300 includes an interface 310, a processing system 320, and a memory 330. The interface 310 is configured to communicate with one or more device components or with other devices or a user. For example, the interface 310 may include a speaker interface, a microphone interface, a display interface, or other interfaces to interact with a user such that the input 314 is from a device component interacting with a user (such as keystrokes from a keyboard, image data from a camera controller, audio data from a microphone, etc.) and the output 312 is to a device component interacting with a user (such as display data to be provided to a display or audio data to be provided to a speaker). The interface 310 may additionally or alternatively include a wired or wireless interface to communicate with another device (with the input 314 and the output 312 including packets transmitted between the devices). In another example, the interface 310 is coupled to a bus to communicate with other internal components of the device (such as to a storage).

The memory 330 may include a non-transitory computer-readable medium (including one or more nonvolatile memory elements, such as EPROM, EEPROM, Flash memory, or a hard drive, among other examples) that may store at least the following:
a neural network (NN) 332;
an operating environment 334 in which to implement or execute the NN 332, such as TF or TFLite;
a software module 336 in the operating environment 334 to update or optimize the NN 332; and
data files 338, such as TF or TFLite files including the specialized kernels.
   Each component 332-338 in memory 330 may include instructions that, when executed by the processing system 320, causes the system 300 to perform the corresponding functions. To note, the NN 332 and some data files 338 may be uploaded into the operating environment 334 for the system 300 to execute the NN 332.

The processing system 320 may include any suitable one or more processors capable of executing scripts or instructions of one or more software programs stored in the system 300 (such as in the memory 330). For example, the processing system 320 may execute the operating environment 334, including the software module 336, to upload the NN 332 and one or more data files 338 in order to perform operations executing or updating the NN 332.

Described below are example operations performed by a software module (e.g., a processing system 320 executing the software module 336 to cause the system 300 to perform operations) to generate a specialized kernel and operator. To note, the example operations are depicted in examples below that include portions of an NN depicted in the C programming language for human readability purposes, but the operations may also be performed in machine code based on known patterns of machine code associated with different objects (such as different operators, conditions, etc. defined in the operating environment (such as in TensorFlow) or the programming language (such as in C) and compiled by the compiler in compiling the NN).

As noted above, the operating environment or the programming language has defined various objects. For example, the C programming language has predefined arithmetic and logic operators, conditional statements, and loops that are associated with a specific keyword or sequence of characters to indicate the existence of such objects in program code. In another example, TensorFlow has defined for an NN a convolution layer that is associated with a specific keyword to indicate the existence of the object in the NN (such as “Conv2D” for a two-dimensional convolution given an input and four-dimensional filter tensors).

The system 300 executing the software module 336 may perform operations to identify a specialized operator and kernel to be generated for a NN, generate the specialized operator and kernel, and insert the specialized operator into the NN. The system 300 performing operations in executing the software module 336 is referred to herein as the software module performing the operations for simplicity. To identify a potential need for a specialized kernel, the software module 336 scans a neural network for one or more defined objects. For example, the software module 336 may include or access a library of defined operators, conditional statements, loops, general kernels or layers, etc. that are associated with a keyword or a specific sequence of characters. As such, the software module 336 may scan the code of the NN for the keywords or character sequences to identify one or more of the defined objects. If the NN is already compiled and in machine code (such as binary or hexadecimal), the library may include the machine code pattern associated with the defined object so that the software module 336 may scan for the machine code patterns for the objects. To note, not all operators or other objects may be desired candidates for generating a specialized kernel. As such, the library may be limited to including or may indicate the defined objects to which the system 300 is limited to generating a specialized kernel and operator. In this manner, the software module 336 may identify an object in the NN from the one or more defined objects in the library.

For example, the software module 336 may scan the NN 332 to identify the keyword “Conv2D” in the NN 332 (which indicates a general kernel/layer of the NN to perform a two-dimensional convolution). In response to identifying the keyword “Conv2D,” the software module 336 may generate a specialized operator based on an object type of the object. For example, since “Conv2D” is associated with a kernel/layer, the software module 336 may generate a specialized operator that is to replace execution of the general convolution kernel in the NN. The software module 336 thus inserts the specialized operator into the NN at a known location for the layer in the NN to cause a system to execute a specialized kernel instead of the general convolution kernel at this instance in the NN.

The specialized operator calls a specialized kernel to be executed. For example, the software module 336 may define a naming convention for the processing system 320 to retrieve a specialized kernel of a specific name from memory 330 (such as in the data files 338) and to execute the specialized kernel and provide outputs from executing the specialized kernel back to the NN 332. As such. the software module 336 may generate the specialized kernel that is to be called by the specialized operator.

The specialized kernel corresponds to one or more parameters of the neural network. One or more parameters may include one or more hyperparameters for a layer. For the general convolution kernel, hyperparameters defined for the NN layer include, e.g., input shape, output shape, kernel shape, dilation, padding, and stride. Other parameters may include inputs for the object, outputs of the object, or other conditions that impact execution of the object. For example, for an if/else conditional statement in C, a parameter may include the condition statement or variable to determine if the condition is met. For a for loop in C, a parameter may include the variable whose value a counter is to count in repeating the operations in the for loop. For an operator, such as an arithmetic operator or a logic operator, parameters may include the input variables to the operator. The library may indicate parameters for each of the defined objects in the library.

While a general kernel, operator, conditional statement, loop, and other objects are general with parameters that may vary so that the object is customizable as needed throughout a NN or other models, one or more parameters for a specific NN may be static or may otherwise allow the object to be simplified in order to reduce the complexity of the NN. For example, referring back to the Conv2D general kernel, one or more of the hyperparameters may be known for a specific layer of the NN. For example, the input shape may be the output shape from the preceding layer, and the output shape may be the input shape for the succeeding layer. Other parameters may be fixed based on inputs to the NN, such as stride, dilation, padding, or kernel (filter) size.

In some implementations, one or more parameters may also be determined to be fixed through execution of the NN for different input values. For example, the software module 336 may execute the NN 332 in a sandbox in the operating environment 334 (such as TensorFlow) a plurality of times with a plurality of different input values. The software module 336 may thus identify the possible values of a parameter across the plurality of times the NN 332 is executed. The software module 336 may also identify from the identified values if the value is the same or is within a limited subset of values (such as a set of 10 possible values).

Generating the specialized kernel to replace a general kernel may include taking a copy of the program code for the general kernel to be the specialized kernel and populating the specialized kernel with the identified possible values of the parameters (such as defining one or more parameters as static values (or from a static set of values) at the beginning of the program code). The system 300 may also compile the specialized kernel with the values included to generate machine code to be executed in place of the general kernel in the NN 332.

As noted above, a specialized kernel may be executed in addition to the general kernels of the NN 332, such as input capture kernel 212 in the NN 200 depicted in FIG. 2 for a memory allocation function or a signal indicating available memory for capturing image data. For example, a defined object of a memory allocation function may include a defined operator of “tf.data.webcam( )” in TensorFlow to pull data from a webcam (as tensors generated from the camera stream). Generating the specialized kernel to perform operations outside of the general kernels of the NN 332 for a memory allocation function may include retrieving a copy of a template kernel for a defined object as the specialized kernel (such as a template for the TensorFlow “tf.data.webcam( )” operator to be executed, with the template included or linked to in the library for the TensorFlow operator), and populating the specialized kernel with the identified possible values of the parameters for the specialized kernel (such as the tensor space locations that is pre-allocated by the system to be used for obtaining the image data based on an analysis of the NN and an offline memory allocation resulting from the analysis of the NN). For input capture kernel 212, the software module may analyze the NN 332 to determine the location in the NN at which the specialized operator may be inserted. For example, the software module 336 may execute the NN 332 in a sandbox in the operating environment 334 a plurality of times with a plurality of different input values, or perform simulations of execution of the NN 332 a plurality of times with a plurality of different input values. Based on the execution in the sandbox and/or the simulations, the software module may analyze one or more performance metrics associated with the execution, such as memory usage and processor usage by the NN 332. The analysis by the software module 336 may include analyzing the total memory usage by the NN throughout execution (e.g., peaks and troughs) and the respective amounts of memory used by the various layers of the NN during execution of the NN. Based on the analysis, the software module 336 may determine an offline memory allocation plan for the NN 332. That is, the software module 336 may determine and assign portions of memory (e.g., portions of a tensor space) to respective layers of the NN 332 (e.g., determine and specify tensor space locations for each tensor or buffer in the NN 332), including memory for capturing image data, and when during execution of the NN to allocate those portions. To note, the specialized kernel (such as the template) may also define that the processing system 320 is to execute an input capture kernel 212 using a separate thread that may be executed concurrently with other operations of the NN. The system 300 may also compile the specialized kernel with the values included to generate machine code to be executed at the place in the NN 332 indicated by the inserted specialized operator. In some implementations, the input capture kernel 212 includes, in lieu of machine code to perform image data capture or memory allocation, machine code to signal to the operating environment 334 that memory is available for capturing image data for the next inference. Based on the signal, the operating environment 334 may proceed to execute an image data capture function to capture image data into that available memory.

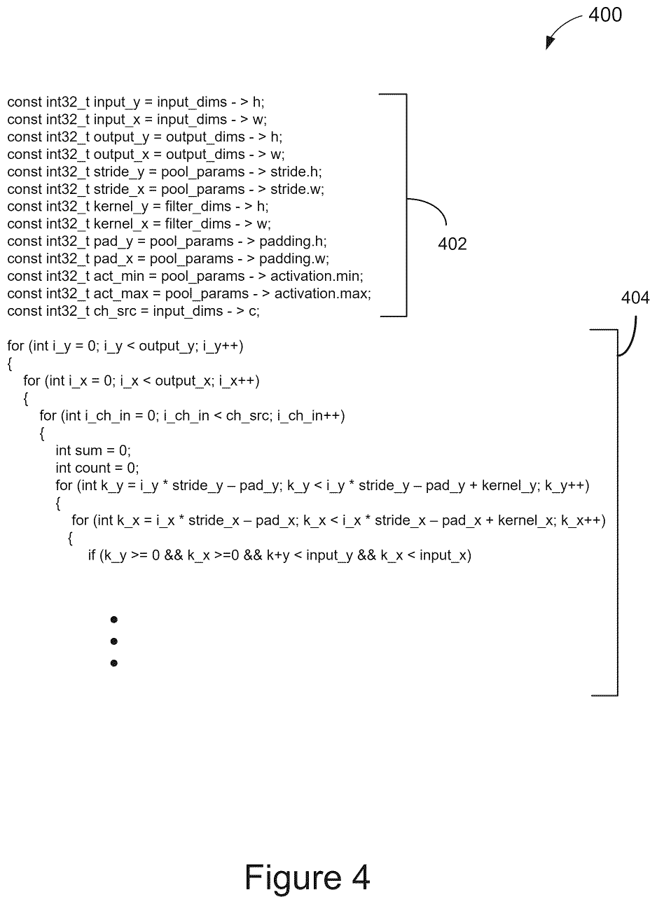

Referring to replacing a general kernel with a specialized kernel (such as replacement kernel 210 in FIG. 2), operations of generating and inserting the specialized kernel are described below with reference to FIG. 4 through FIG. 8. As noted above, a specialized kernel may include populating the kernel with parameters. In some implementations of populating a specialized kernel with parameters, the software module 336 defines the parameters as a specific constant value at the beginning of the kernel and removes the previous definitions of the parameters (which may define a parameter as dependent on one or more inputs or provided values for the NN). For example, the software module 336 may comment out the previous definitions in the program code for the kernel.

FIG. 4 shows a portion of an example kernel 400 in which at least a portion of the parameters are to be replaced with constants, according to some implementations. The kernel 400 is for a replacement kernel (such as replacement kernel 210) and includes parameters 402 and instructions 404 to perform operations associated with the kernel 400. As depicted in FIG. 4, the example kernel 400 is a copy of a general kernel that includes program code to execute a convolution function (such as for a CNN layer). The kernel 400 is an example implementation of a kernel in the NN 332 (such as NN layer 204-3 of the NN 200).

The software module 336 may scan and identify from the name or header of the general kernel in the NN 332 for the layer in which the kernel is executed that a defined object (the general kernel) is included in the NN 332. As such, the software module 336 may identify the parameters 402 of the general kernel based on the object type. For example, the software module 336 may determine the parameters based on the library entry's indication of the parameters. The software module 336 may thus scan the kernel for where the parameters 402 are defined to identify which portions (such as lines of code delineated by semicolons or brackets) of the program code are to be removed from execution (such as commented out) and replaced with specific static or constant values if known.

To determine the static value of a parameter 402, the software module 336 may scan the definition of the parameter 402 to identify from where the parameter value is retrieved. For example, the parameters 402 are defined from stored objects “input_dims”, “output_dims”, “pool_params”, and “filter_dims” that include values used as the values for the different parameters 402. The software module 336 may thus access the objects and retrieve the static values for one or more parameters 402. Additionally or alternatively, the software module 336 may determine a parameter value through executing the NN 332 including the kernel 400 a plurality of times to determine if the parameter value is static for this instance of the kernel 400. For the specific instance of the general kernel to be executed in the NN 332, the software module 336 may identify the static values of one or more parameters (such as from the called objects including the values) and alter a copy of the general kernel to include the static values in order to generate a specialized kernel.

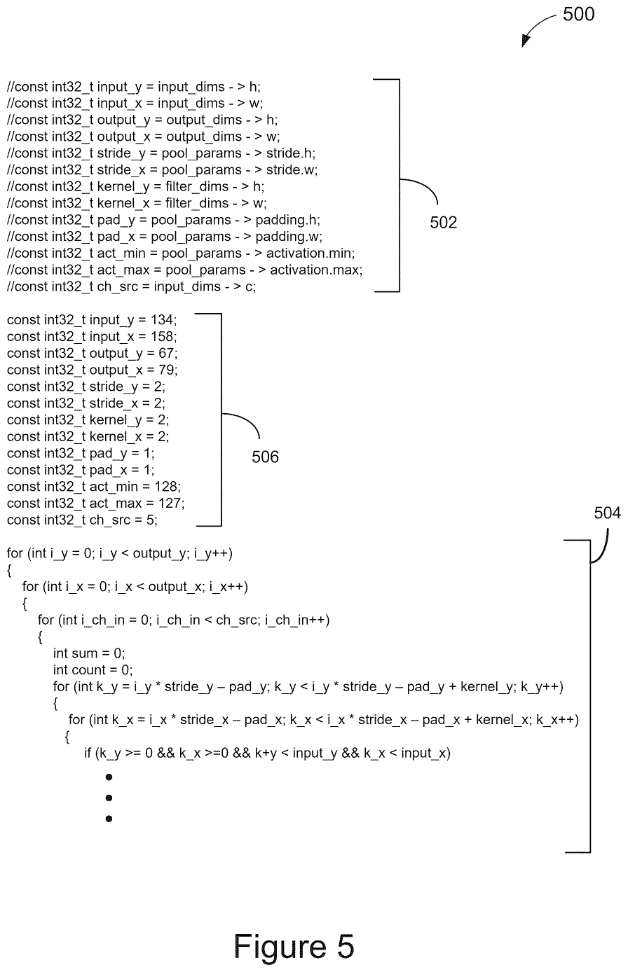

FIG. 5 shows a portion of an example specialized kernel 500 generated from the example kernel 400 in which at least a portion of the parameters are replaced with constants, according to some implementations. The specialized kernel 500 includes parameters 502 that have been commented out and thus not executed, parameters 506 that have been inserted to replace the parameters 502, and instructions 504 to perform operations associated with the kernel 500. The parameters 502 are the same as the parameters 402 in the example kernel 400 depicted in FIG. 4 (except having been removed in the specialized kernel 500), and the instructions 504 are the same as the instructions in the example kernel 400 depicted in FIG. 4. Alternative to commenting out the parameters 502, the software module 336 may delete the parameters 502 from the specialized kernel 500.

With the software module 336 identifying the constants defined for each of the parameters 402 of the kernel 400, for each parameter 402, the software module 336 comments out the parameter's definition in a copy of the general kernel (depicted as parameters 502) and inserts a new parameter definition as a static or constant value (depicted as parameters 506).

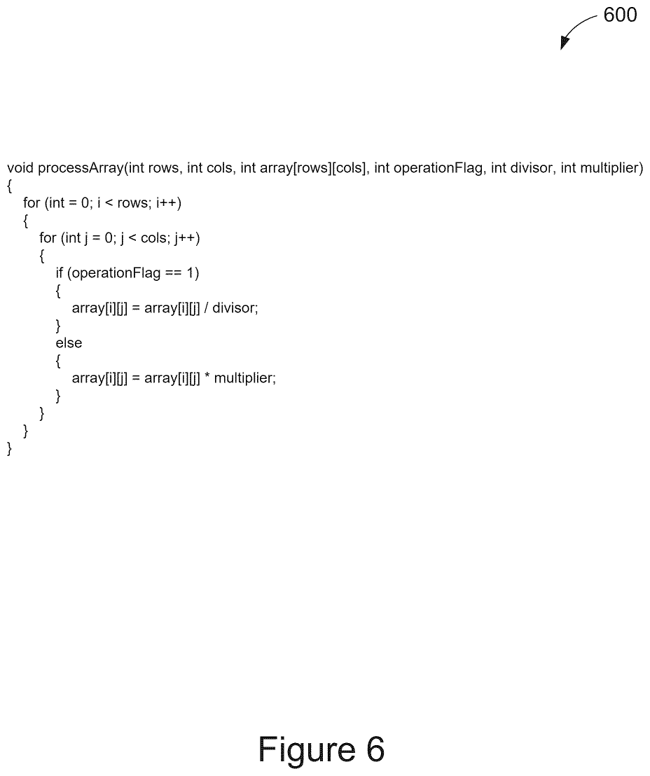

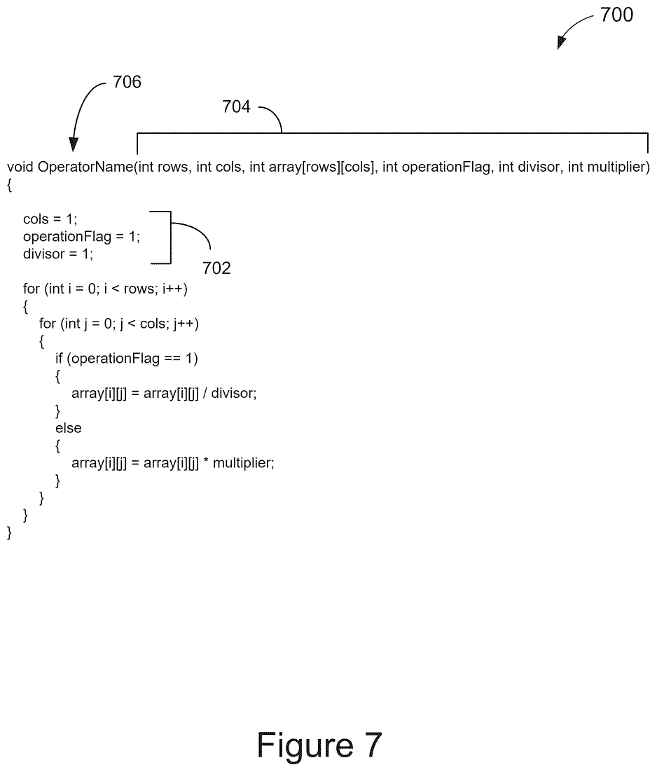

In the example specialized kernel 500, the instructions 504 remain the same as the instructions 404 in the example kernel 400. Alternatively, the software module 336 may scan for additional objects in the instructions 504. For example, the software module 336 may identify the for loops in the instructions 404 and identify the parameters for the for loops as the variables in the conditions of the for loop (such as “output_y”, “output_x”, “ch_src”, etc. as depicted in instructions 404). If any of those parameters differ from the parameters 402, the software module 336 may also attempt to define those parameters as a static or constant value (such as inserting a definition in parameters 506 for the new parameter). Another example replacement of parameter definitions of a defined object is depicted in FIGS. 6 and 7 described below.

FIG. 6 shows an example defined object 600 in which at least a portion of the parameters are to be replaced with constants, according to some implementations. As depicted in FIG. 6, the defined object 600 is a void function that is to process a two-dimensional array. The parameters of the defined object 600 include the input variables listed for the void function (i.e., “rows”, “cols”, “array[rows][cols]”, “operationFlag”, “divisor”, and “multiplier”). While not depicted in this example, other parameters may exist from additional defined objects included and identified in the function.

In some implementations, the defined object may be included in another defined object, such as being included in a general kernel similar to kernel 400 in FIG. 4. For example, the void function may be called in a kernel using the function name (as an operator) in the kernel. In a specific instance of calling the void function (such as at a specific layer and thus iteration of the kernel being executed), the kernel passes the specific values of the parameters in the operator calling the function.

For a specific instance of the function, the software module 336 identifies the parameters that may be replaced with constants (such as by identifying the inputs to the function). The software module also identifies the constants to which the parameters are to be defined (such as from the values passed using the operator in the kernel to call the function). To generate a specialized kernel for a specific instance, the software module 336 amends a copy of the function to define the input values as constants provided by the general kernel for that specific instance. The example process may be the same as described above with reference to FIG. 4 and FIG. 5, which is depicted in FIG. 7.

FIG. 7 shows an example specialized kernel 700 generated from the defined object 600 in which at least a portion of the parameters are replaced with constants, according to some implementations. For the specific instance of the function for which the specialized kernel 700 is generated, the general kernel that calls the function provides that the inputs/parameters “cols” is 1, “operationFlag” is 1, and “divisor” is 1. To generate the specialized kernel 700, the software module 336 defines those parameters as 1 at the beginning of a copy of the object (function) 600 (depicted at location 702). Alternatively, the software module 336 may define the parameters at location 704. As depicted at 706, the software module 336 may also change the name of the specialized kernel to match the specialized operator name used to call the specialized kernel 700 (depicted as “OperatorName”).

As depicted above, the software module 336 may generate a specialized kernel for any type of defined object for when the defined object is to be executed at a specific instance in the NN 332. If the specialized kernel is generated in program code (such as in C in the examples herein), the operating environment 334 (such as a compiler integrated into or communicably coupled with the operating environment), compiles the specialized kernel to generate machine code.

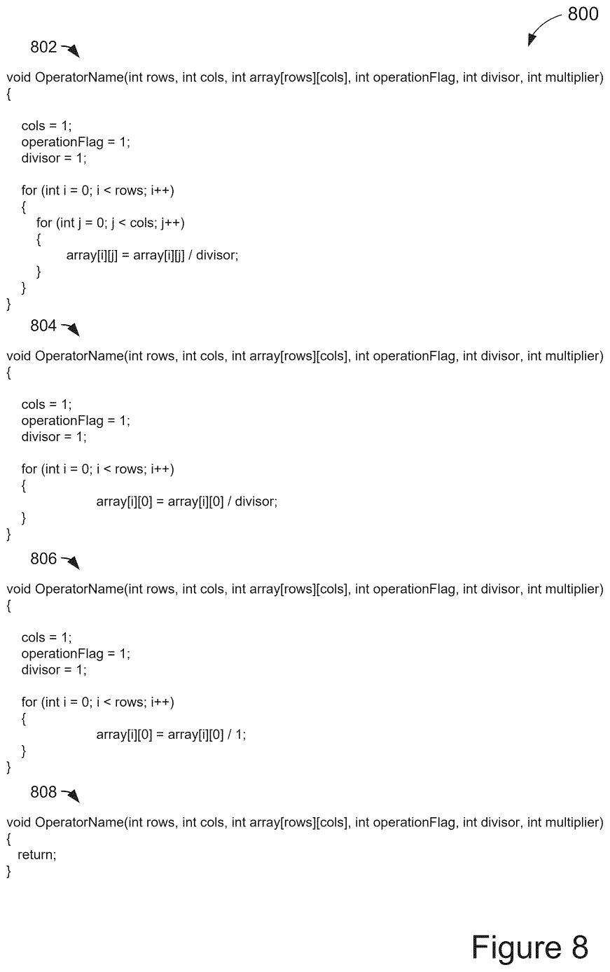

For some specialized kernels, with one or more parameters defined as constants, the compiler may simplify the specialized kernel to have fewer operations than would be required to execute the general kernel from which the specialized kernel is generated. For example, for the specialized kernel 700, the compiler may simplify the instructions based on the parameters “cols”, “operationFlag”, and “divisor” being a static value of 1. The conceptualization of simplifying the specialized kernel 700 at compilation is depicted in FIG. 8 described below.

FIG. 8 shows a visual conceptualization 800 of simplifying at compilation the specialized kernel 700 by a compiler, according to some implementations. The conceptualization 800 includes example intermediate kernels 802-806 and an example final kernel 808 from compilation. Referring to specialized kernel 802, based on the parameter “operationFlag” being 1, the compiler may determine that the if/else conditional statement in specialized kernel 700 is not needed and may thus remove the conditional statement to only leave the operations to be performed from the conditional statement. Referring to specialized kernel 804, with the if/else conditional statement already removed and based on the parameter “cols” being 1, the compiler may determine that the second for loop in specialized kernel 802 is not needed and may thus remove the second for loop to only leave the operations to be performed from the for loop. Referring to specialized kernel 806, with the if/else conditional statement and the second for loop already removed and based on the parameter “divisor” being 1, the compiler may determine that the operation of “array[i][0]=array[i][0]/1” has the same input and output (since dividing by 1) and thus is not needed. As such, as depicted in the final specialized kernel 808, the compiler may remove the operation, which leaves no operations to be performed on the array, and thus generates a null function that performs no operations on any input data. In comparing the defined object 600 in FIG. 6 to the specialized kernel 808 in FIG. 8, it can be seen that a processing system would perform a lot fewer operations to execute the specialized kernel 808 than the execute the defined object 600.

As noted above, alternative to simplifying an existing defined object, a specialized kernel may be generated to introduce pre-processing or post-processing of data for the NN 332. For example, a developer may provide an input of pre-processing functions or post-processing functions that are to be included in the NN. The software module 336 may scan the input as being part of the NN 332 to identify the functions as defined objects and generate specialized kernels and specialized operators to call the specialized kernels before or after the middle layers of the NN 332 (such as depicted in FIG. 2). Further, in some implementations, a specialized kernel may be generated to make use of features specific to the operating environment in which the specialized kernel is to be executed, in addition to or alternative to simplifying the existing defined object as described above. For example, the software module 336 may identify one or more features in the operating environment (e.g., single-instruction-multiple-data (SIMD) or other special instruction sets of a processor associated with the operating environment (e.g., processing system 320), parallelization features on a processor associated with the operating environment) that may be leveraged to optimize execution of the function(s) in the defined object. The software module 336 may then generate a specialized kernel in view of those features and compile corresponding machine code that uses those features during execution.

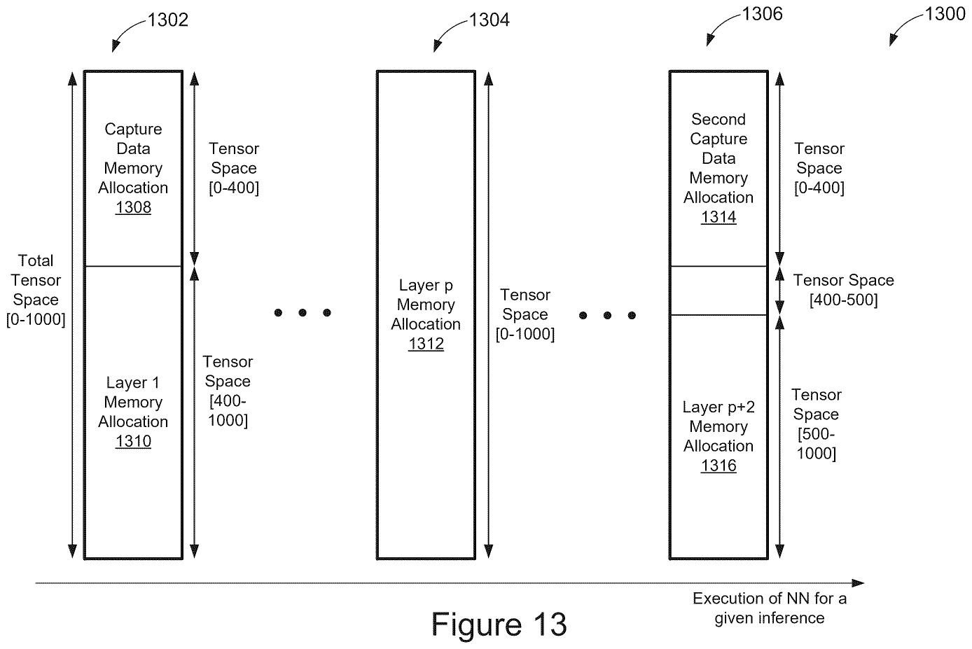

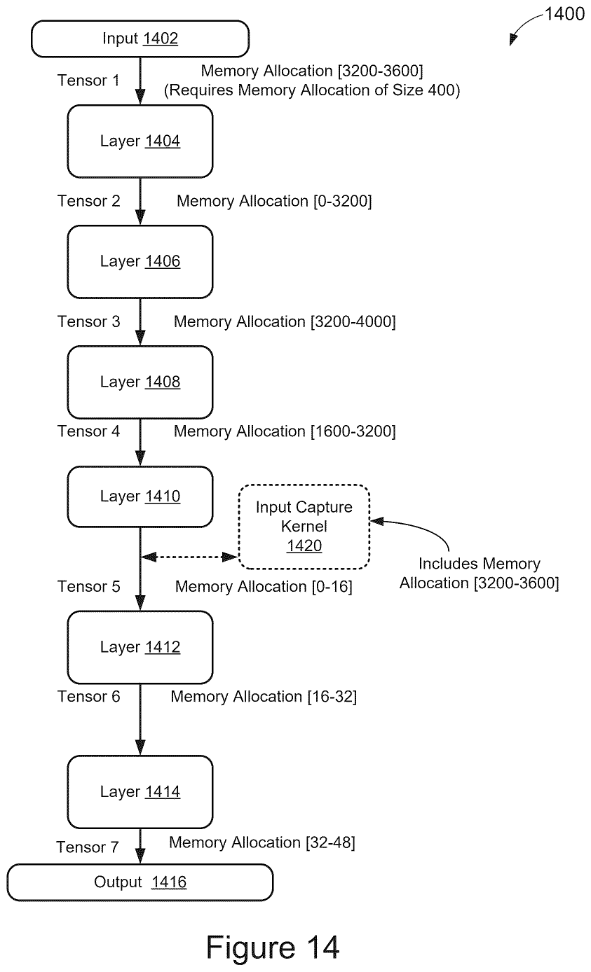

In addition, a specialized kernel may be used for capturing input data (e.g., image data) for a subsequent inference prior to completion of a current inference. As noted above, allocation of memory (such as a portion of the tensor space) for capturing input data may be planned before execution of the NN 332. The software module 336 may include the commands in a specialized kernel (such as input capture kernel 212 in FIG. 2), which is called using a specialized operator as defined by the software module 336. Operations for generating and including an input capture kernel for memory allocation and input data capture functions associated with capturing input data for a subsequent inference, and for capturing that input data into the allocated memory, are described in more detail below with reference to FIG. 13 through FIG. 14.

For the specialized operators, the software module 336 may identify and record locations to insert specialized operators for replacing layer level defined objects (general kernels) based on patterns in the program code or patterns in the machine code indicating a separation between layers during execution of the NN 332. The software module 336 may also identify and record locations to insert specialized operators for replacing functions based on patterns in the program code or patterns in the machine code indicating that the function is being called. The same may also be performed for specialized functions to replace statements in functions or operators.

With a specialized kernel compiled into machine code, the machine code is stored separate from the NN 332. For example, the machine code of one or more specialized kernels may be stored as one or more tensors of a TF file or a TFLite file. The machine code of the specialized operator inserted into the machine code of the NN 332 may thus call the machine code from the file for execution. To prevent inserting malware or otherwise maliciously altering the NN 332, the software module 336 may encrypt the specialized kernels for storage. As such, in order to execute the specialized kernel, the encrypted code may be decrypted at the device. In this manner, the specialized kernels cannot be replaced unless the keys used to encrypt the specialized kernels are known.

To note, a specialized kernel may include an operator that was not yet used in the NN 332. For example, for TensorFlow, the operators of an NN are identified during compilation through use of the OpResolver class libraries and stored as machine code in the memory of the device executing the NN (such as memory 330). If a new operator is introduced, the device is unable to process the new operators using the stored machine code for the existing operators. When a specialized kernel is compiled, the software module 336 may include a list of already defined operators for the NN 332, identify any new operators in the specialized kernel not included in the list, and generate machine code for any new operators. In this manner, the machine code for the new operators may be stored in the memory of the device to execute the NN 332 so that the device is able to process the new operators. To conserve memory usage to store machine code for new operators, machine code may be generated for an operator, and the machine code is used each time an instance of the specific operator occurs in the NN 332. In this manner, a separate machine code does not need to be stored for each instance that a same operator occurs in the NN 332.

Through the generation and use of specialized operators to call specialized kernels that are stored separate from the NN 332 and the operating environment itself (such as separate from the TF firmware), a firmware update of TF and framework update of the NN 332 is not required to introduce new or update existing specialized kernels to update the NN 332.

Some operators may be replaced with the use of a lookup table (LUT). Such operators are referred to herein as LUT replaceable operators. Alternative to using constants and compilation optimization to generate a specialized kernel in replacing a LUT replaceable operator (such as described above with reference to FIG. 4 through FIG. 8), a LUT replaceable operator may be replaced in a kernel with the use of a lookup table (LUT). LUT replaceable operators may include scalar operators (such as “Scalar Add”, “Scalar Mul”, “Scalar Sub”, etc.), activation operators (such as “Sigmoid”, “Tanh”, “Relu”, etc.), and broadcast operators (such as “Broadcast Add”, “Broadcast Mul”, “Broadcast Sub”, various broadcast logic operators, etc.). Defined objects for the software module 336 may include LUT replaceable operators.

Referring to broadcast operators, a broadcast operator includes two types of inputs: an input from the NN and a constant tensor for broadcast (such as being predefined by the system). For example, a broadcast addition operator may perform z:=x+y, with x being in an input A from the NN model and y being in an input B that is to be broadcast for the NN (and thus is defined). To note, a broadcast operator may include more than two inputs, but the above example of adding two input values is provided for simplicity. Other LUT replaceable operators may have similar characteristics that one or more input values are known so that the operation may be simplified through the use of a LUT.

To replace a LUT replaceable operator, the software module 336 may generate a LUT of the output values that the operator may output for different inputs. For example, the software module 336 may generate a LUT of the output values that the broadcast operator may output for different inputs and insert a specialized operator to perform a lookup using the LUT in place of the broadcast operator to obtain the output that would have been generated by the broadcast operator. For the software module 336 to identify a LUT replaceable operator (such as a broadcast operator) when scanning the NN 332, the LUT replaceable operators (such as the broadcast operators) may be included as entries in the library indicating the defined objects, with the library entries indicating that the defined objects are specific types of LUT replaceable operators (such as broadcast operators) or otherwise that the defined objects may be replaced with a LUT.

The LUT for a LUT replaceable operator is to include all combinations of potential input values in order for the LUT to be used in place of all instances of the LUT replaceable operator in the NN 332. For a broadcast operator, the software module 336 is to determine all potential values of the one or more NN provided inputs and all possible values of the one or more broadcast inputs in order to generate a LUT of the correct size. To note, the broadcast inputs are from a broadcast set of values defined outside of the NN 332, and the NN provided inputs are generated at the NN during execution. The examples described below of generating a LUT for a LUT replaceable operator are with reference to a broadcast operator for clarity. The same operations for generating a LUT for a broadcast operator may also be applied for other types of LUT replaceable operators.

To generate a LUT for a broadcast operator, the software module 336 identifies the number of potential values for each NN provided input to the operator. In some implementations, the number of potential values is based on the variable type of the input. For example, if an input is defined as an eight bit integer (such as “int8_t”), it is known that the input is one of 256 values (0-255). The software module 336 may include a list of variable types, the number of potential values based on the variable type, and the keyword, pattern of characters, or pattern of machine code indicating the variable type. The software module 336 may use the list to identify the number of potential values for each NN provided input to determine the dimensions of the LUT for the NN provided inputs.

The software module 336 also identifies the number of potential values for each broadcast input. For example, a broadcast set may be provided for the broadcast operator that indicates the values used for the broadcast input across all instances of the broadcast operator in the NN 332. This broadcast set may be received as a separate object used to configure the NN 332 for operation. For example, if a broadcast operator uses six unique values for a broadcast input in executing the NN 332, the broadcast set may include the six values used for a broadcast input of the broadcast operator. To note, the broadcast set may include a value for each time that the broadcast operator is to be executed in the NN 332, and some of the values may or may not repeat. As such, the software module 336 may identify the number of unique potential values for a broadcast input from the values in the broadcast set for the broadcast input. The software module 336 may thus use the number of values for each broadcast input to determine the dimensions of the LUT for the broadcast inputs.

With the number of values for the NN provided inputs and the broadcast inputs determined by the software module 336, the software module 336 initializes the LUT for the broadcast operator, with the size of the LUT for the broadcast operator being based on a number of possible values for each NN provided input and a size of the broadcast set for each broadcast input. For example, the dimension sizes of the LUT may be defined to be the number of possible values for each input. While the examples described herein are with reference to a two-dimensional LUT for one NN provided input and one broadcast input for simplicity, a LUT may include any number of dimensions for at least one NN provided input and at least one broadcast input.

A two-dimensional LUT is initialized as having 0-p columns and 0-r rows. If an eight bit integer NN provided input corresponds to the columns, the software module 336 may initialize the LUT to include 256 columns, with p equal to 255. If a broadcast input having six unique values in the broadcast set corresponds to the rows, the software module 336 may initialize the LUT to include 6 rows, with r equal to 5. If the broadcast input is of a variable type of, e.g., an eight bit integer, it can be appreciated that the LUT with six rows is smaller than a LUT with 256 rows based on the variable type. Such a smaller LUT takes significantly less memory to store, allowing more LUTs to be stored in memory and used by the operating environment 334 in improving execution of the NN 332.

To note, the values of the broadcast input (referred to as broadcast values) may not be the same as the dimension values in the LUT. For example, while the number of broadcast values may be six, the set of broadcast values themselves may be, e.g., [19, 40, 41, 71, 77, 127], which is not the same as values 0-5 referencing the rows in the LUT (referred to as row values or dimension values). The software module 336 may generate a mapping to map the broadcast values to the dimension values for the broadcast input. For example, the mapping for the above set of broadcast values may include mapping 19 to 0, 40 to 1, 41 to 2, 71 to 3, 77 to 4, and 127 to 5. Thus, when the NN is executed and the specialized operator replacing the broadcast operator is encountered in the NN, the processing system maps the broadcast input value to be used based on the mapping to the dimension value, and then the processing system performs a lookup using the LUT with the NN provided input values received and the mapped dimension values for the broadcast inputs.

With the LUT initialized for the broadcast operator, the software module 336 is to populate the LUT with the values that would be output by the broadcast operator for the different combinations of input values. To generate the values to populate the LUT, the software module 336 executes, for each combination of input values across the at least one NN provided input and the at least one broadcast input, the broadcast operator with the combination of input values to generate the output. To note, the output may be a scalar, a vector, an array, or another suitable output. The software module 336 thus populates, for each combination of input values across the at least one NN provided input and the at least one broadcast input, the LUT with the output in a cell corresponding to the combination of input values. Referring back to the example 6×256 LUT described above, the software module 336 may execute the broadcast operator 1,536 times for all unique combinations of values of the NN provided input and the broadcast input (6 broadcast values times 256 NN provided input values) to generate the 1,536 outputs populated into the 1,536 cells (6 rows times 256 columns) of the LUT.

With the LUT populated, the LUT is stored in memory separate from the operating environment 334 and the NN 332. For example, a portion of the tensor space may be dedicated to the LUTs generated for the NN 332, and the generated LUT may be stored in the allocated tensor space. The specialized operator to call the LUT operation that is inserted for the broadcast operator may be a defined operator stored in memory to cause the processing device to perform a lookup using a specifically called LUT stored in the memory and the inputs passed to the specialized operator. Similar to as described above with reference to updating an NN using specialized kernels, updating an NN using LUTs for LUT replaceable operators (such as broadcast operators) does not require changes to the NN framework or a firmware update. Instead, the LUTs themselves may be updated if changes to the LUT replaceable operator is to occur.

In some implementations, generation (including population) of the LUT may be performed before runtime and stored in memory for use during runtime (i.e., when the NN is executed). In some instances, though, the device that is to execute the NN may have insufficient memory to store all of the LUTs for the NN. As an alternative to pre-generation and storage of the LUTs in memory, the NN may be configured such that the LUT is to be generated by the device during runtime. Instead of storing a LUT, the system 336 may store the code to compute the LUT, replace the operator with a specialized operator to generate the LUT and use the LUT to provide values, and the device executing the NN 336 may generate the LUT when reaching the specialized operator in the NN 336.

In addition, the LUT may be dynamically generated at runtime. For example, instead of calculating each potential value for a LUT and completely populating the LUT, the device executing the NN 336 may populate the LUT while also using the LUT. For example, for a specific specialized operator that replaces a LUT replaceable operator, the device may check if the LUT includes the cell value pointed to by the specialized operator (indicating that the value was previously generated by the device). If the LUT includes the cell value, the device uses the value without performing any calculations. If the LUT does not include the cell value, the device calculates the value for the specialized operator and populates the corresponding cell of the LUT with the calculated value.

The use of a LUT may reduce the number of operations performed to execute the NN 332 than if the LUT replaceable operator is kept in the NN 332. However, for some LUT replaceable operators or inputs, the savings in operations may not be significant enough to warrant replacing the LUT replaceable operator. In some implementations, the software module 336 prevents a LUT replaceable operator (such as a broadcast operator) from being replaced if the number of operations saved with using a LUT for the LUT replaceable operator is less than a threshold. For example, the system 300 calculates a number of operations saved if a broadcast operator is replaced. To calculate the number of operations saved, the system 300 may execute the NN 332 with the broadcast operator included and count the total number of operations to execute the NN 332. The system 300 may also execute the NN 332 with the broadcast operator replaced with a LUT and count the total number of operations to execute the modified NN. The system 300 may thus calculate the number of operations saved as the difference between the total number of operations to execute the NN 332 and the total number of operations to execute the modified NN. Such comparisons for number of operations savings may be performed regardless of whether a LUT is to be generated offline or during runtime or whether the LUT is dynamically generated.

The software module 336 compares the number of operations saved to the threshold. If the number of operations saved is less than the threshold, the software module 336 prevents the broadcast operator from being replaced. If the number of operations saved is not less than the threshold, the software module 336 replaces the broadcast operator with the use of a LUT. The threshold may be any suitable value. In some implementations, the threshold may be a predefined value set at the software module.

In some implementations, the threshold is based on one or more of the number of unique LUT replaceable operators that may be replaced or the available memory size of the device executing the NN. For example, a low memory device may have less available memory to store LUTs. As such, the threshold may be increased so that the use of a LUT requires more operations savings. In another example, the number of LUT replaceable operators to be replaced with the use of a LUT may be defined to a specific value (such as 10). As such, no more than 10 LUT replaceable operators may be replaced with the use of LUTs so that at most 10 LUTs are stored in memory. In some implementations, the limit as to the number of LUT replaceable operators that may be replaced is based on a memory size of the devices executing the NN. As such, lower memory devices may be associated with a lower number of LUT replaceable operators that may be replaced as there is less available memory to store LUTs. In some implementations, LUT replaceable operators are more likely to be replaced with LUTs in NNs whose inputs are eight-bit integers (e.g., int8) or eight-bit unsigned integers (e.g., uint8), such as in NNs quantized to int8 or uint8. In NNs with int8 or uint8 inputs, the sizes of LUTs are relatively small compared to LUTs based on inputs of wider bit width (e.g., 16-bit signed or unsigned integers, 32-bit signed or unsigned integers). Further, the savings in operations by using LUTs based on int8 or uint8 inputs may be more significant compared to savings in operations by using LUTs based on inputs of wider bit width.

If the threshold is based on the number of LUT replaceable operators that may be replaced, the software module 336 may generate a LUT for each unique LUT replaceable operator and calculate operations savings for each LUT replaceable operator if replaced. For an integer b of LUT replaceable operators that may be replaced, the software module 336 identifies the group of b LUT replaceable operators associated with the highest number of operations saved and sets the threshold to the lowest number of operations saved within the group of b LUT replaceable operators. In this manner, only those b LUT replaceable operators are replaced with the use of a LUT, and b number of LUTs are stored in memory of the device executing the NN 332. As such, the software module 336 prevents replacing the LUT replaceable operators associated with a lower number of operations saved than the threshold.

While some LUT replaceable operators may be prevented from being replaced with the use of a LUT, one or more of those LUT replaceable operators, as defined objects, may be replaced with a specialized kernel, such as described above. In some implementations, after a LUT replaceable operator is prevented from being replaced, the software module 336 generates a specialized operator for the LUT replaceable operator, generates a specialized kernel that is to be called by the specialized operator for the LUT replaceable operator, and inserts the specialized operator into the NN 332 (with the specialized kernel stored separately in memory). In this manner, a hybrid approach of replacing some objects with LUTs and some objects with specialized kernels may be performed to improve the NN 332.

In some implementations, the software module 336 may perform a combination of the use of LUTs and optimizing code (such as through the inclusion of constants into the program code and optimization through compilation) to generate a specialized kernel to replace a general kernel. For example, after a LUT replaceable operator is replaced in a kernel (with the LUT generated), the software module 336 may replace one or more variables with constant values (such as described above with reference to FIG. 4 through FIG. 8), and the compiler of the software module 336 may attempt to optimize the program code when compiling.

Switching from replacement kernels described above with reference to the inclusion of constants and/or LUTs in the code, the software module 336 may also generate an input capture kernel to balance the use of memory resources and processing time for memory allocation functions, in particular for capturing input data (e.g., image data) for a subsequent inference prior to completion of a current inference. For typical execution of memory allocation functions in an NN, the system executes the commands included in the function in order, including the memory allocation functions to reserve portions of the limited memory available at the system (such as the system allocating portions of the tensor space for the memory allocation function). Memory allocation and input data capture for a subsequent inference is performed after completion of a current inference.

An example memory allocation function includes image data capture. For an image data capture function for an NN, the function includes the actions of capturing and storing the image data and performing inference on the stored image data for the NN to use the inference data. It should be appreciated that, while the description below refers to capturing image data and memory allocation associated with storing captured image data, the techniques described therein are applicable to other types of input data as well (e.g., sensor data, audio data, input data generated by a preceding layer of the NN, etc.).

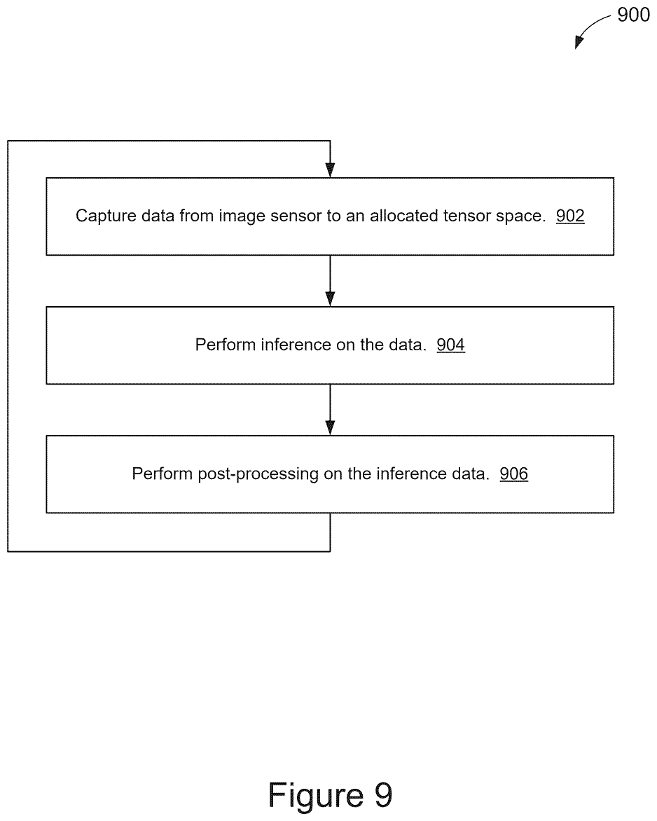

FIG. 9 shows an illustrative flowchart depicting an example operation 900 for typically performing an image data capture function (also referred to herein as an image capture function). As noted above, the image data capture function is an example memory allocation function that is to be executed for an NN (such as the NN 332). For clarity, the operations do not include memory allocation operations, which may also be included in the function, or other ancillary operations. The operation 900 is described as being performed by a system having stored and executing an NN including one or more instances of the image data capture function (and may include other memory allocation functions).

In executing the image data capture function, the system captures data from an image sensor to an allocated tensor space (902). The system thus stores the data in a portion of the tensor space allocated to store the data. With the data stored, the system then performs inference on the data (904). Once inference is complete, the system performs post-processing of the inference data (906). After post-processing, the data is ready for the NN. The system is thus ready to perform the image data capture function again (or another memory allocation function), with the process reverting to 902 for the next instance of the image data capture function.

To note, the system must wait for inference to complete before proceeding to 906 from 904. In particular, the memory allocation commands of the function are such that inference is to be completed so that the memory allocated (such as the tensor space reserved) for capture and inference is released for use for a next memory allocation function in the NN. As such, the system must also wait for inference to complete before executing another iteration of the image data capture function. For example, the NN may require repeated execution of the image data capture function (such as for continued use of current image data), and the execution of each occurrence of the function is delayed by inference completing for the previous occurrence of the function. In a simplified example, the image capture commands may require 50 milliseconds (ms) to complete, and the image inference commands may require 100 ms to complete. If waiting for the completion of inference would not be required, the frame rate for the image data capture would be 20 frames per second (fps) (1 second divided by 50 ms). However, as depicted in FIG. 9, if waiting for inference to complete is required, the frame rate is approximately 6.67 fps (1 second divided by 150 ms). As can be seen in the example, the number of times that the image data capture function can be executed in an amount of time is significantly decreased (such as reduced by two-thirds) as a result of having to wait for completion of inference.

In typical attempts to improve the reduced performance for the memory allocation function as described above with reference to FIG. 9, the NN may be configured such that the system is to capture data in parallel with performing inference on previous data. The data may then be copied to the space that included the previously captured data in order for inference to be performing on the current captured data.

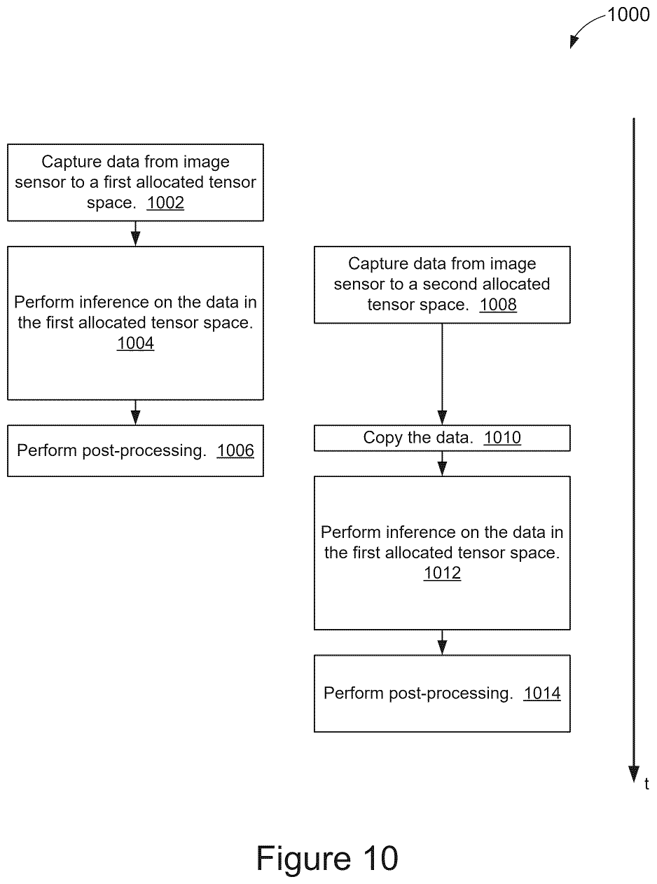

FIG. 10 shows an illustrative flowchart depicting an example operation 1000 for typically performing an image data capture function to improve the fps of the image data capture as depicted in FIG. 9. For clarity, the operations do not include memory allocation operations, which may also be included in the function, or other ancillary operations. The operation 1000 is described as being performed by the same system and in parallel to performing operation 900 (which is depicted by boxes 1002-1006). In the example, the heights of the boxes in FIG. 10 indicate the length of time for each step to complete. For example, in the simplified example above of the inference taking twice as long as the image data capture, box 1004 is twice the height of box 1002 in FIG. 10.

As noted, 1002-1006 in FIG. 10 are the same as 902-906 in FIG. 9, with 1002 being the same as 902, 1004 being the same as 904, and 1006 being the same as 906. The system thus captures the data from the image sensor to a first allocated tensor space (1002). The system then performs inference on the data in the first allocated tensor space (1004). After inference is completed, the system performs post-processing on the inference data (1006).

While inference is being performed on the data from the first allocated tensor space, the system captures data from the image sensor to a second allocated tensor space (1008). In this manner, the system does not need to wait until the end of performing inference and post-processing in order to perform the image data capture again (such as depicted in FIG. 9). Instead, the system waits until inference is completed at 1004 in order to copy the data from the second allocated tensor space to the first allocated tensor space (1010). The system then performs inference on the data in the first allocated tensor space (1012) and performs post-processing (1014) after inference is completed at 1012. For the above example, if the copy data command requires 20 ms to complete (which is less than 50 ms for the capture data command), the frame rate is increased from approximately 6.67 fps to approximately 8.33 fps (1 second divided 120 ms).

One problem with operation 1000 is that the system is required to allocate the additional memory to store data obtained during inference of previously obtained data. For example, in operation 1000, the second tensor space must be allocated in addition to the first tensor space.

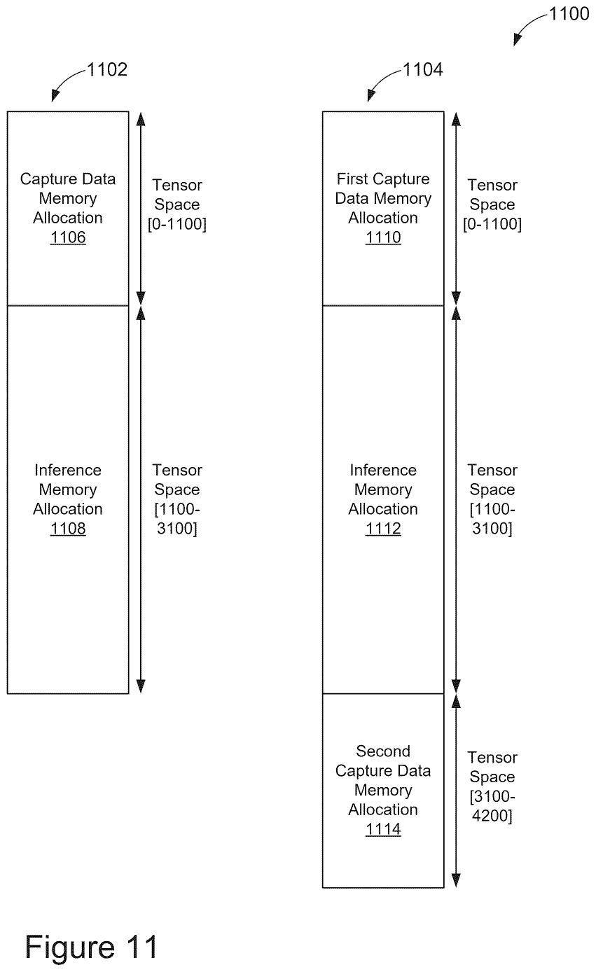

FIG. 11 shows example memory allocations 1100 for a system performing operation 900 and operation 1000. The memory allocation 1102 corresponds to operation 900, and the memory allocation 1104 corresponds to operation 1000. While FIG. 11 is depicted with reference to an image data capture function, memory allocation discrepancies may be similar for other memory allocation functions.

Memory allocated in performing operation 900 is released once the iteration of the operation 900 is completed. As such, memory may be allocated for each instance that 902 and 904 are executed. The size of the memory to be allocated for storing the obtained data (such as captured image data) may be the same (e.g., predetermined) across instances. Additionally, the size of the memory to be allocated for performing inference may be the same across instances. As a result, the size of the memory allocation 1102 may vary depending on the specific memory allocation function being performed. To note, different memory allocation functions may obtain different sizes of data.

The memory allocation 1102 depicts a capture data memory allocation at a tensor space size of 1100 (depicted as [0-1100]). The memory allocation 1102 for operation 900 also includes the inference memory allocation 1108 used to perform inference on the captured image data, which is depicted to require a tensor space size of 2000 (depicted as [1100-3100]).

For operation 1000, the system that compiles the NN is able to scan the program code and identify the memory allocation needed for storing data for memory allocation functions. The system may also identify the memory allocation needed for inference in general. As such, as depicted in FIG. 11 for image data capture functions, the system may allocate the first capture data memory allocation 1110 for the memory allocation 1104 to be a predetermined amount for image data capture (which is depicted as 1100, i.e., [0-1100]). To note, not all of the allocated tensor space for memory allocation 1110 need be used if the instance of 1008 in operation 1000 includes less data captured than one or more other instances of 1008 in operation 1000. Similar to the inference memory allocation 1108 in the memory allocation 1102 for operation 900, the memory allocation 1104 includes the inference memory allocation 1112 used to perform inference on the captured image data, which is depicted to require a tensor space size of 2000 (depicted as [1100-3100]).

In addition to the memory allocations 1110 and 1112, the memory allocation 1104 for operation 1000 also requires a second capture data memory allocation 1114 to capture data while inference is being performed on previously captured data in memory allocation 1110. As noted in operation 1000, the data captured during inference is copied to the memory storing the previously captured data after inference of the previously captured data is completed. The system may thus allocate the second capture data memory allocation 1114 to be the same size as the first capture data memory allocation 1110 (depicted as [3100-4200]).

As can be seen in the example, the memory allocation 1104 to perform operation 1000 (which increases fps for image data capture) requires over 35 percent more memory than the maximum required memory allocation 1102 to perform operation 900. As such, while operation 1000 may improve performance in executing memory allocation functions, the improved performance comes at a significant cost in memory. One attempt to improve the performance associated with memory allocations described above is the use of offline memory allocation, in which memory usage by the NN is analyzed and memory allocation is determined and planned based on the analysis before execution of the NN (i.e., while the NN is offline, with the memory allocation being referred to as offline memory allocation).

For example, a typical offline memory allocation plan for the NN may allocate a first portion of the tensor space for capturing image data for a first inference, a second portion of the tensor space to a first layer of the NN for the first inference, and then re-allocate all or part of the first portion to a second layer of the NN for the first inference. The typical offline memory allocation plan may further include re-allocating the first portion of the tensor space for capturing image data for a second, subsequent inference after the first inference is completed. While this approach may decrease the overall memory footprint of the NN (e.g., the total tensor space required may be smaller than that for operation 1000 above by eliminating the need for additional tensor space for the second capture data memory allocation 1114 and data copying 1010 from that additional tensor space), the reduced memory footprint comes at a cost of a delay in capturing image data for subsequent inferences, thereby reducing the number of times that the image data capture function can be executed in an amount of time, similar to operation 900 described above.

FIG. 12 shows example memory allocations 1200 for a system performing the operation depicted in FIG. 9 based on an offline memory allocation. While FIG. 12 is depicted with reference to an image data capture function, memory allocations may be similar for capture and processing of other types of input data.

An offline memory allocation may plan out memory allocations and re-allocations for various layers of the NN, so that portions of the memory may be reused during an inference. Memory allocated for given layer may be released once that layer is completed. As such, memory allocated for a given layer may be re-allocated to another layer when the given layer is completed. Accordingly, the inference operation may be performed within a given total memory space (e.g., a tensor space depicted as [0-1000] in FIG. 12). FIG. 12 shows a sequence of memory allocations 1200 that follows a typical offline memory allocation. For simplicity, FIG. 12 is depicted under an assumption that the NN being executed for the given inference (e.g., an iteration of operation 900) includes two intermediate layers (e.g., convolutional layers) between an input layer and a fully connected output layer.

As shown, for a given inference (e.g., an iteration of operation 900), an offline memory allocation plan with memory allocations 1200 may have a first memory allocation 1202 that includes a capture data memory allocation 1208 (depicted as [0-400]) to store captured image data. The capture data memory allocation 1208 depicts a predetermined capture data memory allocation (tensor space size of 400) required across all of the image data capture functions of the NN. In some implementations, the actual amount of image data stored in the capture data memory allocation 1208 may be smaller than the amount of memory allocated by the allocation 1208. Memory allocation 1202 also includes a first layer memory allocation 1210 used to perform functions of a first layer on the captured image data, which is depicted to require a tensor space size of 600 (depicted as [400-1000]).

As the given inference progresses, the first layer has processed the captured image data, and thus the memory allocated by the capture data memory allocation 1208 may be freed and re-allocated to a subsequent layer. As such, memory allocation 1204 includes a second layer memory allocation 1212 used to perform functions of a second layer on the output of the first layer, which is depicted to require a tensor space size of 300 (depicted as [0-300]).

As the given inference continues further, the second layer has processed the output of the first layer, and thus the memory allocated by the first layer memory allocation 1210 may be freed and re-allocated to the output layer. As such, memory allocation 1206 includes an output memory allocation 1214 used to perform functions of a fully connected output layer on the output of the second layer, which is depicted to require a tensor space size of 100 (depicted as [400-500]). When the iteration of operation 900 for the given inference is completed, the memory may be allocated again according to the memory allocations 1200 of the offline memory allocation plan, starting with memory allocation 1202.

Thus, while memory allocations 1200 eliminates the need for additional tensor space for a second capture data memory allocation as in memory allocation 1104 above or additional memory for buffering input data, and correspondingly eliminating the need for input data copying 1010, the capture data memory allocation for the next inference is delayed until at least the memory allocated by the second layer memory allocation 1212 is freed (e.g., by completion of the functions of the fully connected output layer). Accordingly, the capture of image data for the next inference (e.g., the next iteration of operation 900) is delayed until the given inference is completed.

Alternative to typical means of executing a memory allocation function (such as depicted in FIG. 9) and means of executing a memory allocation function through the use of copy data operations (such as depicted in FIG. 10), and means of offline memory allocation that allocates memory for capturing image data for an inference operation after completion of the prior inference operation (such as depicted in FIG. 12), the software module 336 generates a specialized kernel for triggering a capture of image data (such as input capture kernel 212) to balance performance and memory usage. In generating the input capture kernel, the software module 336 identifies a point in the NN when memory previously allocated for capturing image data for a current inference operation is free and may be reserved for allocation for capturing image data. As such, the software module 336 may generate a specialized kernel that may include memory allocation commands (as well as the other commands of the memory allocation function and the input data capture function) and insert the specialized kernel as an input capture kernel between two layers of the NN identified as when memory is free for the memory allocation function. Alternatively, the specialized kernel may include, in lieu of memory allocation commands or image data capture commands, a command to signal the operating environment that memory for capturing image data is available. When the input capture kernel is executed by the system, memory is allocated for the memory allocation function at a point in the NN when memory is free and may be reserved for image data capture, thus not causing issues with offline, static memory allocation that may occur for remaining layers of the NN in the current inference. The process of generating an input capture kernel for a memory allocation function is described below with reference to FIG. 13-14.

FIG. 13 shows example memory allocations 1300 for a system performing an inference operation based on an offline memory allocation that includes an input capture trigger. While FIG. 13 is depicted with reference to an image data capture function, similar memory allocations may be applicable to other types of input data.

As described above with reference to FIG. 12, an offline memory allocation may plan out memory allocations and re-allocations for various layers of the NN, so that portions of the memory may be reused during the inference. The offline memory allocation may further include a memory allocation for capturing image data for the next inference based on an input capture trigger. Accordingly, the inference operation, as well as capture of image data for the next inference, may be performed within a given total memory space (e.g., a tensor space depicted as [0-1000] in FIG. 13). FIG. 13 shows portions of a sequence of memory allocations for a given inference that follow the offline memory allocation plan. FIG. 13 is depicted under an assumption that memory usage by the NN is highest at a Layer p within the NN.

As shown, for a given inference, an offline memory allocation plan with memory allocations 1300 may have a first memory allocation 1302 that includes a capture data memory allocation 1308 (depicted as [0-400]) to store captured image data. The capture data memory allocation 1308 depicts a predetermined capture data memory allocation (tensor space size of 400) required across all of the image data capture functions of the NN. In some implementations, the actual amount of image data stored in the capture data memory allocation 1308 may be smaller than the amount of memory allocated by the allocation 1308. Memory allocation 1302 also includes a Layer 1 memory allocation 1310 used to perform functions of a first layer (“Layer 1”) on the captured image data, which is depicted to require a tensor space size of 600 (depicted as [400-1000]).

As the given inference progresses, memory in the tensor space may be allocated and re-allocated amongst layers for the current inference in the NN, similar to memory allocations 1200. For Layer p, memory allocations 1300 may have a memory allocation 1304 that includes a Layer p memory allocation 1312. The memory usage of the NN is highest (peaks) at Layer p. For example, Layer p uses the full tensor space of 1000 (depicted as [0-1000]), leaving no tensor space that may be reserved for capturing image data for the next inference.

As the given inference continues further, memory in the tensor space may continue to be allocated and re-allocated amongst layers for the current inference in the NN, but memory usage of the NN decreases from the peak. At some point in the given inference after Layer p, the memory usage of the NN has decreased from the peak such that an amount needed for a capture data memory allocation is available and may be reserved for the capture data memory allocation (e.g., the memory usage of the NN does not increase for the remainder of the inference to leave less than the amount needed for the capture data memory allocation available). For example, at Layer p+2, an amount of tensor space matching the amount allocated for the capture data memory allocation 1308 is available. As such, memory allocations 1300 has a memory allocation 1306 that includes a second capture data memory allocation 1314 and a Layer p+2 memory allocation 1316. The second capture data memory allocation 1314 allocates the same tensor space ([0-400]) for capturing image data for the next inference as capture data memory allocation 1308 had allocated for capturing image data for the given inference. Further, the memory allocations 1300 now no longer re-allocates the memory allocated by second capture data memory allocation 1314 within the current inference. That is, for the remainder of the given inference, the remaining layers in the given inference are allocated just the remaining tensor space outside of the memory allocated by second capture data memory allocation 1314. Thus, for example, Layer+2 memory allocation 1316 allocates tensor space [500-1000] to Layer p+2, and tensor space [400-500] is available. Subsequent layers within the given inference are allocated tensor space only from the tensor space [400-1000].

The software module may determine where in the memory allocations 1300 in the offline memory allocation plan to reserve the tensor space for the second capture data memory allocation 1314. The software module may determine a point (e.g., a point between layers) after the memory usage peak for Layer p, when after the tensor space for the second capture data memory allocation 1314 is reserved, there is sufficient remaining tensor space for the remaining layers in the given inference.

FIG. 14 shows an example NN 1400 for which a specialized kernel is to be added for an input capture trigger, according to some implementations. The NN 1400 may be an example implementation of the NN 332. The example NN 1400 includes an input layer 1402, an output layer 1416, and six middle layers 1404-1414. Tensor 1 is the input to layer 1404, and tensor 2 is the output from layer 1404. Tensor 2 is the input to layer 1406, and tensor 3 is the output from layer 1406. Tensor 3 is the input to layer 1408, and tensor 4 is the output from layer 1408. Tensor 4 is the input to layer 1410, and tensor 5 is the output from layer 1410. Tensor 5 is the input to layer 1412, and tensor 6 is the output from layer 1412. Tensor 6 is the input to layer 1414, and tensor 7 is the output from layer 1414.

To identify where an input trigger kernel with a memory allocation function, for triggering input data capture for a subsequent inference during a current inference, is to be added for the NN 1400, the software module 336 analyzes the NN 1400 (e.g., scans the code of the NN 1400 to identify any memory allocation functions, executing the NN 1400 in a sandbox, simulating execution of the NN 1400). As such, the software module 336 identifies a point in the NN 1400 to insert the input capture kernel and to determine an offline memory allocation for the NN 1400 in view of the input capture kernel.

The software module 336 may generate the input capture kernel 1420 by including the code of an input data capture function (e.g., an image data capture function) and the corresponding memory allocation function, which may include the memory allocation commands as well as the commands for performing the operations of the memory allocation function and the input data capture function. For the memory allocation commands in the input capture kernel 1420, the software module 336 identifies a point in the NN 1400 when memory (tensor space) usage by the NN 1400 peaks. The software module 336 further identifies, as a location at which the input capture kernel 1420 is to be inserted into the NN 1400, a point in the NN 1400 after the memory usage peak when memory (tensor space) allocated for receiving captured image data for a current inference is available and may be reserved for receiving captured image data for the next inference. As noted, insertion of a kernel may include the insertion of a specialized operator into the code of the NN 1400. Alternatively, the software module 336 may generate the input capture kernel 1420 by including a command to signal the operating environment 334 that memory for capturing input data is available, based on the offline memory allocation for the NN 1400 reserving the memory for capturing input data.

To identify a location in the NN 1400 to insert the input capture kernel 1420, the software module 336 may scan the code of the NN 1400 (or execute the NN 1400 in a sandbox or simulate execution of the NN 1400) to determine an offline memory allocation (used tensor space) for each tensor in order to determine the available memory (tensor space) that may be used at the location of each tensor. For example, the software module 336 may determine an offline memory allocation that includes a memory allocation [3200-3600] of the tensor space for Tensor 1, which is used for receiving captured input data and requires a block of 400 in the tensor space. The offline memory allocation may further include memory allocation [0-3200] of the tensor space for tensor 2, memory allocation [3200-4000] of the tensor space for tensor 3, memory allocation [1600-3200] of the tensor space for tensor 4, memory allocation [0-16] of the tensor space for tensor 5, memory allocation [16-32] of the tensor space for tensor6, and memory allocation [32-48] of the tensor space for tensor 7.

The software module 336 determines a location between layers in the NN 1400, or even within a layer 1400, at which the location in the memory (tensor space) intended for receiving captured input data ([3200-3600]) is available for the input capture kernel without blocking memory allocations for subsequent layers in the NN 1400. For example, if the tensor space is limited to for the NN 1400, the software module 336 identifies a location in the NN 1400 in which the block of 400 in [3200-3600] in the tensor space is free and may be reserved for allocation by an input capture kernel. In some implementations, the software module 336 may identify the earliest location after a peak in the memory usage of the NN 1400 to insert the input capture kernel based on the memory allocation needs of the NN 1400, the available memory at different locations in the NN, and the minimization of delays to execution of the NN 1400 following the input capture kernel. In the example, the software module 336 determines a location in the NN 1400, between layers 1410 and 1412, at which the block [3200-3600] in the tensor space may remain allocated for the input capture kernel 1420 without impacting the identified allocations in the tensor space for the NN 1400. In some implementations, the software module 336 may determine an offline memory allocation with availability of memory for capturing input data prior to completion of the current inference in mind, and analyze the NN 1400 accordingly. In some implementations, the software module 336 may analyze the NN 1400 without an input capture kernel and a pre-existing offline memory allocation for the NN 1400, and modify the NN 1400 and the offline memory allocation based on the analysis to include the input capture kernel 1420.

Through the operations described herein for replacing a kernel (which may include one or both of the use of a LUT or optimization of the code based on the defining of variables as constants and compiling the code) or adding kernel for a memory allocation function, a NN may be improved for runtime to reduce processing time and memory resources required to execute the NN.

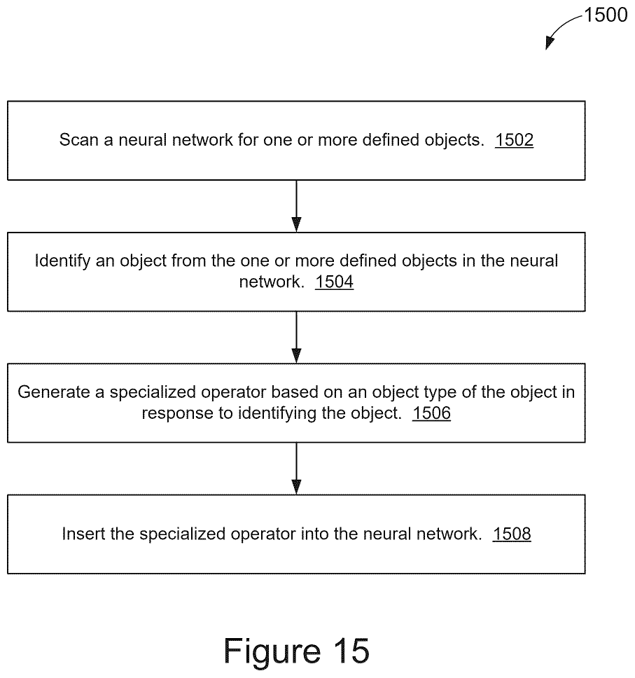

FIGS. 15-22 described below show flowcharts depicting example operations of the different aspects of updating an NN. For clarity, the operations depicted in each flowchart are described as being performed by the system 300 in FIG. 3. In addition, some of the flowcharts may be cumulative or alternative to each other, with such relationships described with reference to each figure.

FIG. 15 shows an illustrative flowchart depicting an example operation 1500 for updating a neural network, according to some implementations. In some implementations, the example operation 1500 may be performed by the system 300 of FIG. 3, such as the software module 336 of the system 300 (which refers to the system 300 performing the operations by executing software module 336).

The software module 336 scans an NN 332 for one or more defined objects (1502). The software module 336 identifies an object from the one or more defined objects in the NN 332 (1504). The software module 336 also generates a specialized operator based on an object type of the object in response to identifying the object (1506). For example, the type of specialized kernel to be used may be based on the type of defined object (such as whether to replace a general kernel at a layer, insert a kernel between layers, add pre-or post-processing) which thus impacts the specialized operator to be used. With the specialized operator generated, the software module 336 inserts the specialized operator into the NN 332 (1508). If any program code or machine code is removed or replaced as a result of inserting the specialized operator, in some implementations, the system 300 may store the removed code in a file. As such, the software module 336 may be configured to restore the NN to original using the file including the removed code.

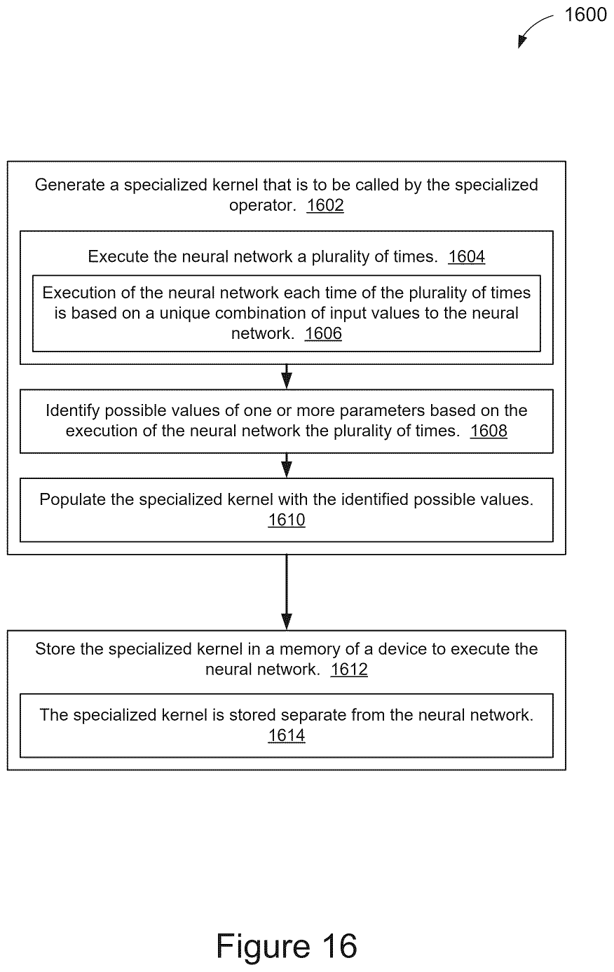

FIG. 16 shows an illustrative flowchart depicting an example operation 1600 for generating and storing a specialized kernel to update a neural network, according to some implementations. As noted above, the specialized operator inserted into the NN 332 at block 1508 of operation 1500 is to call a specialized kernel, which is depicted as being generated in operation 1600. Operation 1600 may be performed in addition to operation 1500.

The software module 336 generates a specialized kernel that is to be called by the specialized operator (1602). To generate the specialized kernel, the software module 336 is to determine one or more parameter values. In some implementations, the parameter values are determined by executing the NN 332 a number of times to measure the parameter values. For example, the system 300 may execute the NN 332 a plurality of times (1604). Execution of the NN 332 each time of the plurality of times is based on a unique combination of input values to the NN 332 (1606). Based on the unique combination of values, the software module 336 identifies possible values of one or more parameters based on the execution of the NN 332 the plurality of times (1608). The software module 336 thus populates the specialized kernel with the identified possible values (1610).

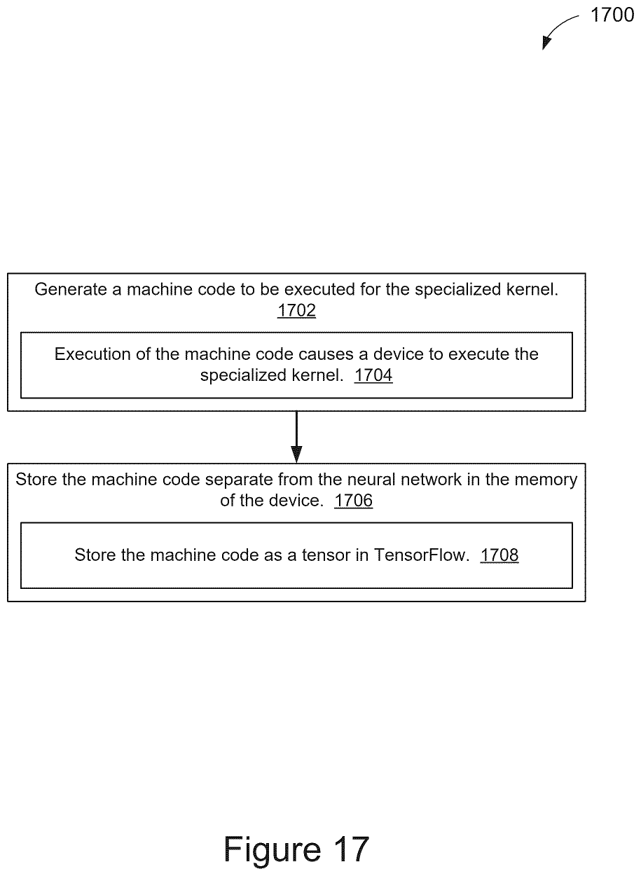

The device executing the NN 332 (such as the system 300) stores the specialized kernel in a memory of the device to execute the NN 332 (such as memory 330) (1612). The specialized kernel is stored separate from the NN 332 in memory (1614). The specialized kernel may be stored as machine code, such as depicted in FIG. 17 described below.

FIG. 17 shows an illustrative flowchart depicting an example operation 1700 for generating and storing a specialized kernel as machine code to be executed for a specialized operator, according to some implementations. Operation 1700 may be performed in addition to operation 1400.

The system 300 generates a machine code to be executed for the specialized kernel (1702). For example, a compiler compiles the specialized kernel into machine code for storage in a device memory. Execution of the machine code causes a device to execute the specialized kernel (1704).

The device to execute the NN 332 stores the machine code separate from the NN 332 in the memory of the device (1706). In some implementations, the device stores the machine code as a tensor in TF (1708). For example, the machine code of one or more specialized kernels may be stored as one or more tensors included in a TF file or a TFLite file.

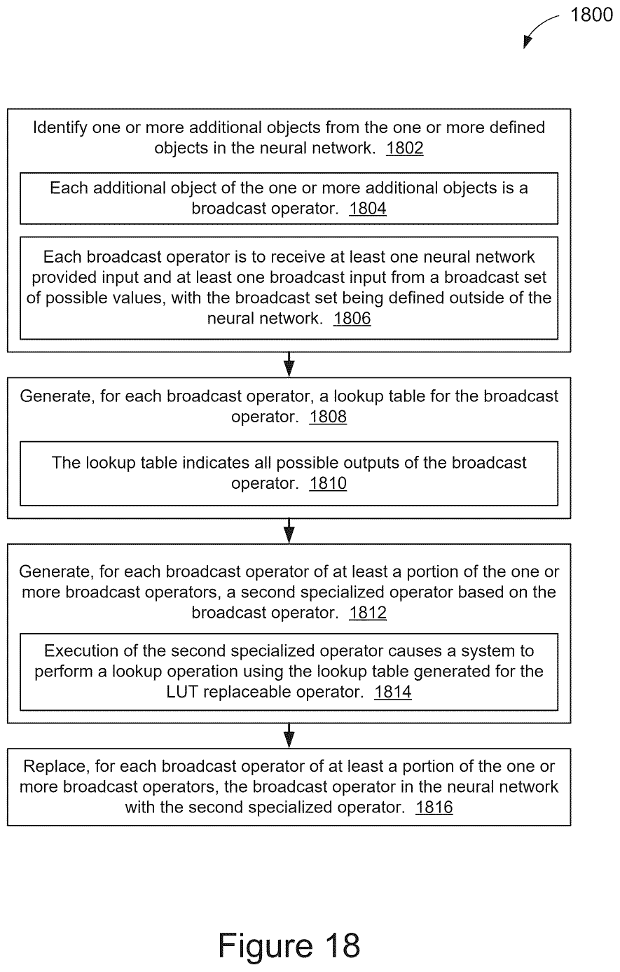

In addition to using one or more specialized kernels, the NN 332 may have one or more LUT replaceable operators (such as broadcast operators) replaced with the use of a LUT. FIG. 18-21 depict operations with refence to the use of LUTs to replace a broadcast operator for clarity, but the operations may be performed to replace any suitable LUT replaceable operator.

FIG. 18 shows an illustrative flowchart depicting an example operation 1800 for replacing one or more broadcast operators with a specialized operator to use a LUT, according to some implementations. Operation 1800 may be performed in addition to operation 1500 and operation 1600. As such, replacing a broadcast operator may be in addition to the use of a specialized kernel.

In scanning the NN 332, the software module 336 identifies one or more additional objects from the one or more defined objects in the NN 332 (1802). Each additional object of the one or more additional objects is a broadcast operator (1804). Also, each broadcast operator is to receive at least one NN provided input and at least one broadcast input from a broadcast set of possible values, with the broadcast set being defined outside of the NN 332 (1806).

The software module 336 generates, for each broadcast operator, a LUT for the broadcast operator (1808). The LUT indicates all possible outputs of the broadcast operator (1810). The software module 336 generates, for each broadcast operator of at least a portion of the one or more broadcast operators, a second specialized operator based on the broadcast operator (1812). Execution of the second specialized operator causes a system to perform a lookup operation using the LUT generated for the broadcast operator (1814). The software module 336 also replaces, for each broadcast operator of at least a portion of the one or more broadcast operators, the broadcast operator in the NN 332 with the second specialized operator (1816).

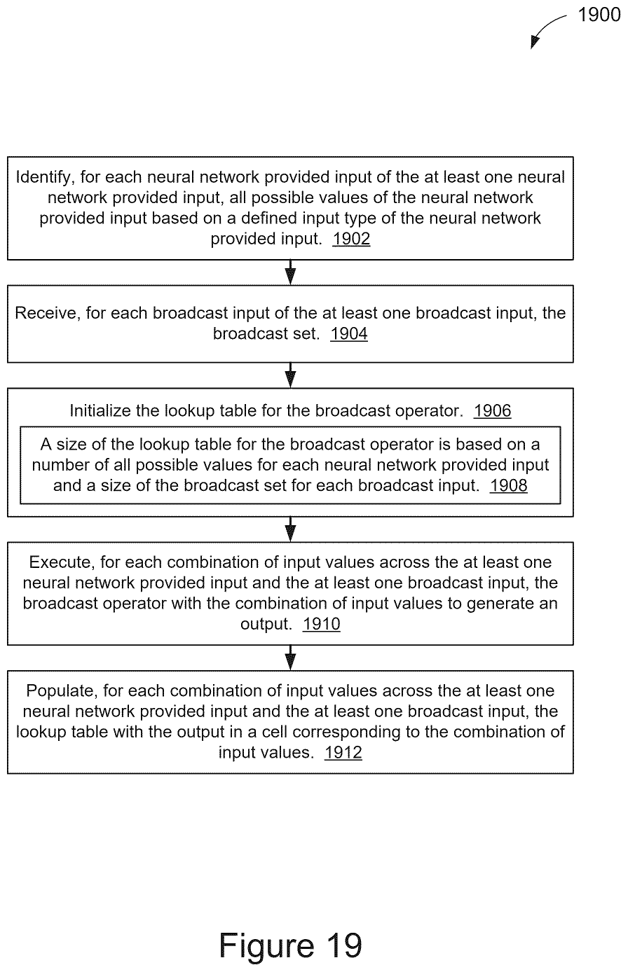

FIG. 19 shows an illustrative flowchart depicting an example operation 1900 for generating a LUT to be used in replacing a broadcast operator, according to some implementations. Operation 1900 may be performed in addition to operation 1800 (and thus in addition to operation 1500 and operation 1600). Alternatively, only LUTs (and no specialized kernels) may be used such that operations 1800 and 1900 may be performed independent from operations 1500 and 1600.

The software module 336 identifies, for each NN provided input of the at least one NN provided input (for a broadcast operator), all possible values of the NN provided input based on a defined input type of the NN provided input (1902). For example, the software module 336 may determine that a four bit integer may include 16 values from 0-15.

The system 300 receives, for each broadcast input of the at least one broadcast input (for the broadcast operator), the broadcast set (1904). As noted above, the broadcast set includes the values of the broadcast input used in execution of the NN 332. The software module 336 initializes the LUT for the broadcast operator (1906). A size of the LUT for the broadcast operator is based on a number of all possible values for each NN provided input and a size of the broadcast set for each broadcast input (1908). For example, the software module 336 determines the number of values for an NN provided input based on the variable type and determines the number of values for a broadcast input based on the number of unique values in the broadcast set.

With the LUT initialized to a specific size and all values of the inputs known, the software module 336 executes, for each combination of input values across the at least one NN provided input and the at least one broadcast input, the broadcast operator with the combination of input values to generate an output (1910). The software module 336 thus populates, for each combination of input values across the at least one NN provided input and the at least one broadcast input, the LUT with the output in a cell corresponding to the combination of input values (1912). While not depicted in operation 1800, the software module 336 may also generate a mapping between the possible values of the broadcast input and the dimension values of the corresponding dimension of the LUT. In this manner, 0-r dimension values may be mapped to r unique broadcast values.

As noted above, the NN may be configured such that the device executing the NN is to generate a LUT during runtime and, in some implementations, dynamically generate the LUT during runtime. For such instances, the software module 336 generates updates the NN 332 with the specialized operator that calls the machine code stored by the software module 336 into the memory for the NN 332 to generate the LUT.

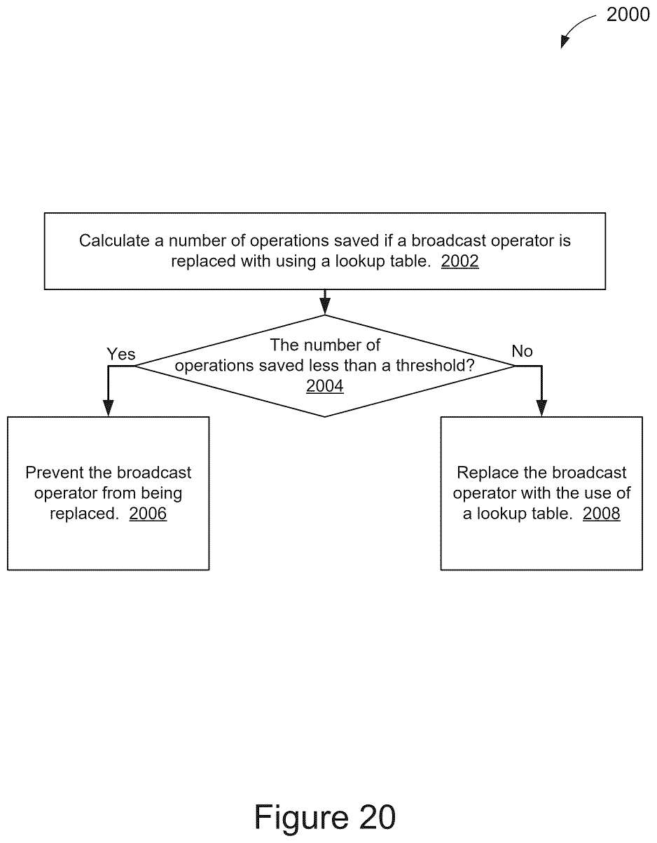

FIG. 20 shows an illustrative flowchart depicting an example operation 2000 for determining whether a broadcast operator is to be replaced, according to some implementations. Operation 2000 may be performed in addition to operation 1800 and operation 1900. Operation 2000 may be performed for each broadcast operator in the NN 332.

The software module 336 calculates a number of operations saved if a broadcast operator is replaced with using a LUT (2002). For example, the system 300 executes the NN 332 with the broadcast operator and executes a modified NN with the broadcast operator replaced, calculates the total number of operations performed for each execution, and calculates a difference between the two numbers. At decision block 2004, if the number of operations saved is less than a threshold, the software module 336 prevents the broadcast operator from being replaced (2006). If the number of operations saved is not less than the threshold, the software module 336 replaces the broadcast operator with the use of a LUT (2008).

As noted above, the threshold may be configured in different ways. For example, the threshold may be a predefined number of operations set at the software module 336. In another example, the threshold may depend on the available memory of devices to execute the deployed NN 332. In a further example, the threshold may depend on a maximum number of broadcast operators to be replaced (thus indicating the maximum number of LUTs to be stored in memory), and the maximum number of broadcast operators to be replaced may be based on the available memory of the devices to execute the NN 332 or the desired maximum amount of memory to be used to store LUTs. Also as noted above, for one or more broadcast operators prevented from being replaced, the software module 336 may attempt to use a specialized kernel to replace the broadcast operator.

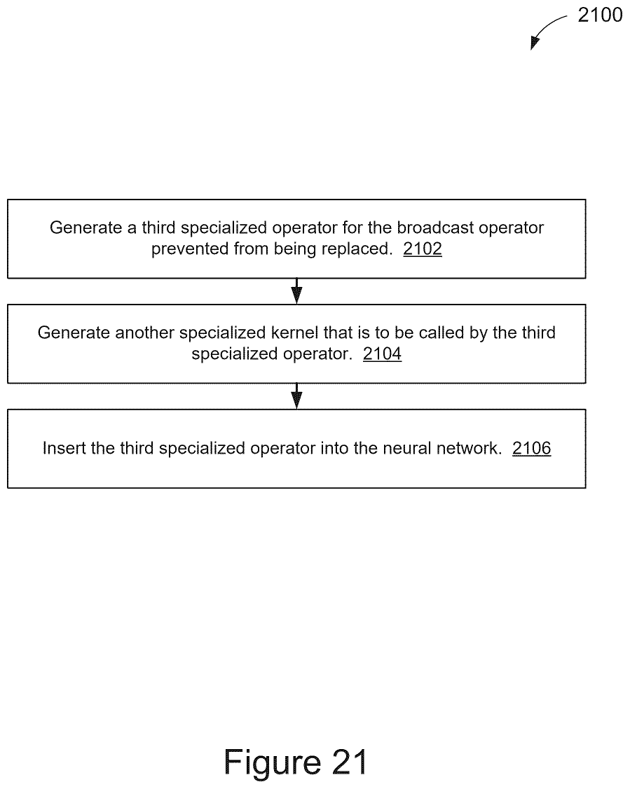

FIG. 21 shows an illustrative flowchart depicting an example operation 2100 for replacing a broadcast operator prevented from being replaced with the use of a LUT with a specialized kernel, according to some implementations. Operation 2100 may be performed in addition to operation 1800, operation 1900, and operation 2000. In some implementations, operation 2100 may also be performed in addition to operation 1500 and operation 1600.

The software module 336 generates a third specialized operator for the broadcast operator prevented from being replaced (2102). The software module 336 also generates another specialized kernel that is to be called by the third specialized operator (2104). The software module 336 inserts the third specialized operator into the NN 332 (2106). In this manner, the NN 332 may use a combination of LUTs and specialized kernels to update the NN 332.

In some implementations, the software module 336 may combine the use of LUTs with replacement kernels to update the NN 332. For example and as described above, the software module 336 may include a specialized operator to call a LUT in a general kernel to replace a LUT replaceable operator (such as a broadcast operator), then the software module 336 may define variables as constants in a new kernel including the LUT and compile the new kernel to optimize the code for the kernel. The software module 336 thus replaces the original kernel with the optimized kernel that also includes use of a LUT.

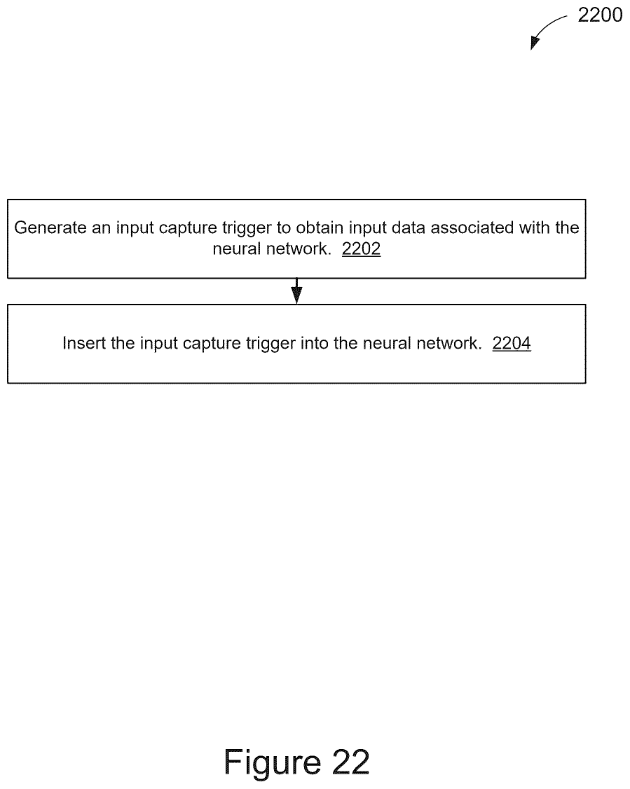

FIG. 22 shows an illustrative flowchart depicting an example operation 2200 for inserting an input capture trigger, according to some implementations. Operation 2200 may be performed in addition to operation 1800, operation 1900, operation 2000, and operation 2100. In some implementations, operation 2200 may also be performed in addition to operation 1500 and operation 1600.

The software module 336 generates an input capture trigger to obtain input data associated with the neural network (2202). The software module 336 inserts the input capture trigger into the NN 332 (2204).

In some implementations, the software module 336 may analyze the NN 332 to determine an offline memory allocation for the NN 332, including a location for insertion of the input capture trigger (e.g., an input capture kernel 312). The input capture trigger may include a function for capturing input data and/or a function for allocating memory to store captured input data. Additionally or alternatively, the input capture trigger may signal the operating environment that memory for storing input data is available.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A computer-implemented method for updating a neural network, the method comprising:
scanning, by a software module, a neural network for one or more defined objects, wherein the software module is included in an operating environment for the neural network;
identifying an object from the one or more defined objects in the neural network;
generating a specialized operator based on an object type of the object in response to identifying the object; and
inserting the specialized operator into the neural network.

2. The method of claim 1, further comprising:
generating a specialized kernel that is to be called by the specialized operator, wherein the specialized kernel corresponds to a parameter of the neural network; and
storing the specialized kernel in a memory of a device to execute the neural network, wherein the specialized kernel is stored separate from the neural network.

3. The method of claim 2, wherein generating the specialized kernel includes:
executing the neural network a plurality of times, wherein execution of the neural network each time of the plurality of times is based on a unique combination of input values to the neural network;
identifying possible values of the parameter based on the execution of the neural network the plurality of times; and
populating the specialized kernel with the identified possible values.

4. The method of claim 2, further comprising:
generating a machine code to be executed for the specialized kernel, wherein execution of the machine code causes the device to execute the specialized kernel; and
storing the machine code separate from the neural network in the memory of the device.

5. The method of claim 2, further comprising:
identifying, by the software module, one or more additional objects from the one or more defined objects in the neural network, wherein:
each additional object of the one or more additional objects is a broadcast operator; and
each broadcast operator is to receive at least one neural network provided input and at least one broadcast input from a broadcast set of possible broadcast values, wherein the broadcast set is defined outside of the neural network;
for each broadcast operator, generating a lookup table for the broadcast operator, wherein the lookup table indicates all possible outputs of the broadcast operator; and
for each broadcast operator of at least a portion of the one or more broadcast operators:
generating a second specialized operator based on the broadcast operator, wherein execution of the second specialized operator causes a system to perform a lookup operation using the lookup table generated for the broadcast operator; and
replacing the broadcast operator in the neural network with the second specialized operator.

6. The method of claim 5, wherein generating the lookup table for the broadcast operator includes:
identifying, for each neural network provided input of the at least one neural network provided input, all possible values of the neural network provided input based on a defined input type of the neural network provided input;
receiving, for each broadcast input of the at least one broadcast input, the broadcast set;
initializing the lookup table for the broadcast operator, wherein a size of the lookup table for the broadcast operator is based on a number of all possible values for each neural network provided input and a size of the broadcast set for each broadcast input; and
for each combination of input values across the at least one neural network provided input and the at least one broadcast input:
executing the broadcast operator with the combination of input values to generate an output; and
populating the lookup table with the output in a cell corresponding to the combination of input values.

7. The method of claim 5, further comprising preventing a broadcast operator of the one or more broadcast operators from being replaced in the neural network based on a number of operations saved being less than a threshold in using the lookup table as compared to using the broadcast operator in the neural network.

8. The method of claim 7, wherein:
a maximum number of broadcast operators to be replaced is defined based on an available memory size of the device to execute the neural network;
the broadcast operator prevented from being replaced corresponds to a first number of operations saved that is less than a minimum number of operations saved corresponding to a plurality of broadcast operators of the one or more broadcast operators;
the plurality of broadcast operators equals the maximum number of broadcast operators to be replaced; and
the threshold is based on the minimum number of operations saved.

9. The method of claim 8, further comprising:
generating a third specialized operator for the broadcast operator prevented from being replaced;
generating another specialized kernel that is to be called by the third specialized operator; and
inserting the third specialized operator into the neural network.

10. The method of claim 1, further comprising:
generating an input capture trigger to obtain input data associated with the neural network; and
inserting the input capture trigger into the neural network.

11. A system to update a neural network, the system comprising:
a processing system; and
a memory storing:
computer readable code implementing a neural network;
computer readable code implementing an operating environment for the neural network, wherein the operating environment includes a software module; and
instructions that, when executed by the processing system, causes the system to perform operations comprising:
scanning, by the software module, the neural network for one or more defined objects;
identifying an object from the one or more defined objects in the neural network;
generating a specialized operator based on an object type of the object in response to identifying the object; and
inserting the specialized operator into the neural network.

12. The system of claim 11, wherein the operations further comprise:
generating a specialized kernel that is to be called by the specialized operator, wherein the specialized kernel corresponds to a parameter of the neural network; and
storing the specialized kernel in a memory of a device to execute the neural network, wherein the specialized kernel is stored separate from the neural network.

13. The system of claim 12, wherein generating the specialized kernel includes:
executing the neural network a plurality of times, wherein execution of the neural network each time of the plurality of times is based on a unique combination of input values to the neural network;
identifying possible values of the parameter based on the execution of the neural network the plurality of times; and
populating the specialized kernel with the identified possible values.

14. The system of claim 12, wherein the operations further comprise:
generating a machine code to be executed for the specialized kernel, wherein execution of the machine code causes the device to execute the specialized kernel; and
storing the machine code separate from the neural network in the memory of the device.

15. The system of claim 12, wherein the operations further comprise:
identifying, by the software module, one or more additional objects from the one or more defined objects in the neural network, wherein:
each additional object of the one or more additional objects is a broadcast operator; and
each broadcast operator is to receive at least one neural network provided input and at least one broadcast input from a broadcast set of possible broadcast values, wherein the broadcast set is defined outside of the neural network;
for each broadcast operator, generating a lookup table for the broadcast operator, wherein the lookup table indicates all possible outputs of the broadcast operator; and
for each broadcast operator of at least a portion of the one or more broadcast operators:
generating a second specialized operator based on the broadcast operator, wherein execution of the second specialized operator causes a system to perform a lookup operation using the lookup table generated for the broadcast operator; and
replacing the broadcast operator in the neural network with the second specialized operator.

16. The system of claim 15, wherein generating the lookup table for the broadcast operator includes:
identifying, for each neural network provided input of the at least one neural network provided input, all possible values of the neural network provided input based on a defined input type of the neural network provided input;
receiving, for each broadcast input of the at least one broadcast input, the broadcast set;
initializing the lookup table for the broadcast operator, wherein a size of the lookup table for the broadcast operator is based on a number of all possible values for each neural network provided input and a size of the broadcast set for each broadcast input; and
for each combination of input values across the at least one neural network provided input and the at least one broadcast input:
executing the broadcast operator with the combination of input values to generate an output; and
populating the lookup table with the output in a cell corresponding to the combination of input values.

17. The system of claim 15, wherein the operations further comprise preventing a broadcast operator of the one or more broadcast operators from being replaced in the neural network based on a number of operations saved being less than a threshold in using the lookup table as compared to using the broadcast operator in the neural network.

18. The system of claim 17, wherein:
a maximum number of broadcast operators to be replaced is defined based on an available memory size of the device to execute the neural network;
the broadcast operator prevented from being replaced corresponds to a first number of operations saved that is less than a minimum number of operations saved corresponding to a plurality of broadcast operators of the one or more broadcast operators;
the plurality of broadcast operators equals the maximum number of broadcast operators to be replaced; and
the threshold is based on the minimum number of operations saved.

19. The system of claim 18, wherein the operations further comprise:
generating a third specialized operator for the broadcast operator prevented from being replaced;
generating another specialized kernel that is to be called by the third specialized operator; and
inserting the third specialized operator into the neural network.

20. The system of claim 11, wherein the operations further comprise:
generating an input capture trigger to obtain input data associated with the neural network; and
inserting the input capture trigger into the neural network.
